(19) United States
(12) Patent Application Publication
(10) Pub. No.: US 2023/0314575 A1
(43) Pub. Date: Oct. 5, 2023

(54) SENSOR UNIT, CONTROL METHOD, AND NON-TRANSITORY COMPUTER READABLE MEDIUM STORING PROGRAM

(71) Applicant: OMRON Corporation, Kyoto-shi (JP)

(72) Inventor: Shintaro IWAMOTO, Kyoto-shi (JP)

(21) Appl. No.: 18/186,420

(22) Filed: Mar. 20, 2023

(30) Foreign Application Priority Data
Apr. 1, 2022 (JP) 2022-062020

(51) Int. Cl. G01S 7/497; G01S 7/481; G01S 17/08

(52) U.S. Cl. CPC G01S 7/497; G01S 7/4813; G01S 17/08

(57) ABSTRACT

Fluctuation in intensity of light reflected by an object is grasped. A sensor unit includes a sensor configured to measure a distance to an object by observing light reflected by the object, and photoelectrically convert the light reflected by the object to output a signal, an acquisition unit configured to acquire the signal, a determination unit configured to determine whether or not a predetermined condition is satisfied based on rising of the signal and falling of the signal, a generation unit configured to generate information regarding fluctuation in intensity of the light reflected by the object in a case where the predetermined condition is determined a predetermined number of times not to be satisfied, and a display configured to display the information regarding fluctuation in intensity of the light reflected by the object.

### CROSS-REFERENCE TO RELATED APPLICATIONS

This application is based on Japanese Patent Application No. 2022-062020 filed with the Japan Patent Office on Apr. 1, 2022, the entire contents of which are incorporated herein by reference.

### FIELD OF THE INVENTION

The present invention relates to a sensor unit of a reflective type has a ranging function by observing light reflected by an object.

### BACKGROUND OF THE INVENTION

There is known a sensor of a reflective type that measures a distance to an object by irradiating with electromagnetic waves such as light and a radio wave and observing reflected electromagnetic waves reflected by the object. Japanese Patent Application Laid-Open No. 2021-196342 discloses a distance measuring device that measures a distance to an object by a time of flight (ToF) method.

### SUMMARY OF THE INVENTION

Also in the field of factory automation (FA), a sensor of a reflective type is widely used to detect a human or an object. For example, a sensor unit called a safety laser scanner is a type of safety sensor that detects intrusion of a person or an object into a predetermined monitoring area and outputs a signal to stop a device.

A safety sensor may have a function of setting a predetermined position of an object such as a frame or a column of an opening as a reference point, always detecting the reference point, and turning off control output when an abnormality occurs. Such a function is called “reference point monitoring function”, “contour detection function”, “reference boundary function”, “reference boundary monitoring”, “contour as reference”, or the like. For example, a reference point set at a predetermined position of an object is constantly monitored, and control output is turned on at the normal time. In a case where the reference point at the predetermined position cannot be seen due to an object entering a monitoring area, or in a case where the reference point at the predetermined position cannot be monitored due to a change in intensity of light reflected by an object, control output is turned off and a device is stopped. There is a case where a reference point set to an object cannot be detected as intensity of observed light does not fall within an allowable range. At this time as well, the safety sensor turns off control output. The user is forced to stop work until the cause is identified and dealt with so that the control output can be turned on again. In such a case, it is desired to grasp fluctuation in intensity of light.

The present invention has been made in view of the above circumstances, and an object of the present invention is to provide a technique capable of grasping fluctuation in intensity of light reflected by an object.

A sensor unit according to one aspect of the present invention is a sensor unit including a sensor configured to measure a distance to an object by observing light reflected by the object, and photoelectrically converts the light reflected by the object to output a signal, an acquisition unit configured to acquire the signal, a determination unit configured to determine whether or not a predetermined condition is satisfied based on rising of the signal and falling of the signal, a generation unit configured to generate information regarding fluctuation in intensity of the light reflected by the object in a case where the predetermined condition is determined a predetermined number of times not to be satisfied, and a display configured to display the information regarding fluctuation in intensity of the light reflected by the object. When the user visually recognizes the information regarding fluctuation in intensity of light reflected by an object displayed on the display, the user can grasp the fluctuation in intensity of light reflected by the object.

The signal may be a rectangular wave signal, and the predetermined condition may be a condition that a width of the rectangular wave signal, the width being a width from rising of the rectangular wave signal to falling of the rectangular wave signal, is equal to or more than a first predetermined width and equal to or less than a second predetermined width. The sensor may include a light emitting unit, a light receiving unit, a window, and a signal processor, the signal processor may be configured to output a first rectangular wave signal by photoelectrically converting light received by the light receiving unit in a case where light that is emitted from the light emitting unit, passes through the window, and is reflected by the object passes through the window and is received by the light receiving unit, and output a second rectangular wave signal by photoelectrically converting light received by the light receiving unit in a case where light that is emitted from the light emitting unit and reflected by the window is received by the light receiving unit, the measurement unit may be configured to measure a width of the first rectangular wave signal, the width being a width from rising of the first rectangular wave signal to falling of the first rectangular wave signal and a width of the second rectangular wave signal, and the determination unit may be configured to determine whether abnormality occurs on the object side or the window side based on a width of the first rectangular wave signal and a width of the second rectangular wave signal, the width being a width from rising of the second rectangular wave signal to falling of the second rectangular wave signal. By the above, it is possible to grasp a cause of a change in a width of the first rectangular wave signal, that is, whether a cause of occurrence of abnormality is on the object side or the window side. By grasping whether a cause of occurrence of abnormality is on the object side or the window side, it is possible to identify a position of the cause of the occurrence of the abnormality. That is, it is possible to identify whether a position of occurrence of abnormality is on the object side or the window side.

The determination unit may be configured to determine that abnormality occurs on the object side in a case where it is determined a predetermined number of times that a width of the first rectangular wave signal is not equal to or more than the first predetermined width and equal to or less than the second predetermined width and a width of the second rectangular wave signal is equal to or more than a third predetermined width and equal to or less than a fourth predetermined width, and determine that abnormality occurs on the window side in a case where it is determined a predetermined number of times that a width of the first rectangular wave signal is not equal to or more than the first predetermined width and equal to or less than the second predetermined width and a width of the second rectangular wave signal is not equal to or more than the third predetermined width and equal to or less than the fourth predetermined width. For example, in a case where a width of the first rectangular wave signal changes but a width of the second rectangular wave signal does not change, a position of a cause of occurrence of abnormality is determined to be on the object side, and in a case where a width of the first rectangular wave signal and a width of the second rectangular wave signal change, a position of a cause of occurrence of abnormality is determined to be on the window side.

The sensor may include a light emitting unit, a light receiving unit, a window, a signal processor, an emitter, a reflector, and an optical receiver, the signal processor may be configured to output the rectangular wave signal by photoelectrically converting light received by the light receiving unit in a case where light that is emitted from the light emitting unit, passes through the window, and is reflected by the object passes through the window and is received by the light receiving unit, the acquisition unit may be configured to acquire the rectangular wave signal, and a light amount obtained when light that is emitted from the emitter, passes through the window, and is reflected by the reflector and light that is emitted from the emitter and reflected by the window are received by the optical receiver, and the determination unit may be configured to determine whether abnormality occurs on the object side or the window side based on a width of the rectangular wave signal, the width being a width from rising of the rectangular wave signal to falling of the rectangular wave signal, and the light amount. By the above, it is possible to grasp a cause of a change in a width of the first rectangular wave signal, that is, whether a cause of occurrence of abnormality is on the object side or the window side. By grasping whether a cause of occurrence of abnormality is on the object side or the window side, it is possible to identify a position of the cause of the occurrence of the abnormality. That is, it is possible to identify whether a position of occurrence of abnormality is on the object side or the window side.

The determination unit may be configured to determine that abnormality occurs on the object side in a case where it is determined a predetermined number of times that a width of the rectangular wave signal is not equal to or more than the first predetermined width and equal to or less than the second predetermined width and the light amount is included in a predetermined range, and determine that abnormality occurs on the window side in a case where it is determined a predetermined number of times that a width of the rectangular wave signal is not equal to or more than the first predetermined width and equal to or less than the second predetermined width and the light amount is not included in the predetermined range. For example, in a case where a width of a rectangular wave signal changes but a light amount does not change, a position of a cause of occurrence of abnormality is identified to be on the object side, and in a case where a width of a rectangular wave signal and a light amount change, a position of a cause of occurrence of abnormality is identified to be on the window side.

The signal may be an analog waveform signal, and the predetermined condition may be a condition that elapsed time from a timing at which rising of the analog waveform signal exceeds a first threshold to a timing at which falling of the analog waveform signal falls below a second threshold is equal to or more than first predetermined time and equal to or less than second predetermined time. The sensor may include a light emitting unit, a light receiving unit, a window, and a signal processor, the signal processor may be configured to output a first analog waveform signal by photoelectrically converting light received by the light receiving unit in a case where light that is emitted from the light emitting unit, passes through the window, and is reflected by the object passes through the window and is received by the light receiving unit, and output a second analog waveform signal by photoelectrically converting light received by the light receiving unit in a case where light that is emitted from the light emitting unit and reflected by the window is received by the light receiving unit, the acquisition unit may be configured to acquire the first analog waveform signal and the second analog waveform signal, and the determination unit may be configured to determine whether abnormality occurs on the object side or the window side based on first elapsed time from a timing at which rising of the first analog waveform signal exceeds the first threshold to a timing at which falling of the first analog waveform signal falls below the second threshold, and second elapsed time from a timing at which rising of the second analog waveform signal exceeds a third threshold to a timing at which falling of the second analog waveform signal falls below a fourth threshold. By the above, it is possible to grasp a cause of a change in the first elapsed time, that is, whether a cause of occurrence of abnormality is on the object side or the window side. By grasping whether a cause of occurrence of abnormality is on the object side or the window side, it is possible to identify a position of the cause of the occurrence of the abnormality. That is, it is possible to identify whether a position of occurrence of abnormality is on the object side or the window side.

The determination unit may be configured to determine that abnormality occurs on the object side in a case where it is determined a predetermined number of times that the first elapsed time is not equal to or more than the first predetermined time and equal to or less than the second predetermined time and the second elapsed time is equal to or more than third predetermined time and equal to or less than fourth predetermined time, and determine that abnormality occurs on the window side in a case where it is determined a predetermined number of times that the first elapsed time is not equal to or more than the first predetermined time and equal to or less than the second predetermined time and the second elapsed time is not equal to or more than the third predetermined time and equal to or less than the fourth predetermined time. For example, in a case where the first elapsed time changes but the second elapsed time does not change, a position of a cause of occurrence of abnormality is identified to be on the object side, and in a case where the first elapsed time and the second elapsed time change, a position of a cause of occurrence of abnormality is identified to be on the window side.

The sensor may include a light emitting unit, a light receiving unit, a window, a signal processor, an emitter, a reflector, and an optical receiver, the signal processor may be configured to output the analog waveform signal by photoelectrically converting light received by the light receiving unit in a case where light that is emitted from the light emitting unit, passes through the window, and is reflected by the object passes through the window and is received by the light receiving unit, the acquisition unit may be configured to acquire the analog waveform signal, and a light amount obtained when light that is emitted from the emitter, passes through the window, and is reflected by the reflector and light that is emitted from the emitter and reflected by the window are received by the optical receiver, and the determination unit may be configured to determine whether abnormality occurs on the object side or the window side based on elapsed time from a timing at which rising of the analog waveform signal exceeds the first threshold to a timing at which falling of the analog waveform signal falls below the second threshold, and the light amount. By the above, it is possible to grasp a cause of the elapsed time, that is, whether a cause of occurrence of abnormality is on the object side or the window side. By grasping whether a cause of occurrence of abnormality is on the object side or the window side, it is possible to identify a position of the cause of the occurrence of the abnormality. That is, it is possible to identify whether a position of occurrence of abnormality is on the object side or the window side.

The determination unit may be configured to determine that abnormality occurs on the object side in a case where it is determined a predetermined number of times that the elapsed time is not equal to or more than the first predetermined time and equal to or less than the second predetermined time and the light amount is included in a predetermined range, and determine that abnormality occurs on the window side in a case where it is determined a predetermined number of times that the elapsed time is not equal to or more than the first predetermined time and equal to or less than the second predetermined time and the light amount is not included in the predetermined range. For example, in a case where the elapsed time changes but a light amount does not change, a position of a cause of occurrence of abnormality is identified to be on the object side, and in a case where the elapsed time and a light amount change, a position of a cause of occurrence of abnormality is identified to be on the window side.

The sensor may be configured to output the signal in a plurality of directions by measuring a plurality of the directions, the acquisition unit may be configured to acquire the signal in a plurality of the directions, the determination unit may be configured to determine whether or not the predetermined condition is satisfied based on rising of the signal and falling of the signal in at least one direction of a plurality of the directions, and the generation unit may be configured to generate information regarding fluctuation in intensity of light reflected by the object in a case where the predetermined condition is determined a predetermined number of times not to be satisfied for at least one direction of a plurality of the directions. By the above, the user can grasp fluctuation in intensity of light reflected by an object for at least one of a plurality of directions.

The generation unit may be configured to generate information regarding abnormality on the object side in a case where the determination unit determines that abnormality occurs on the object side, and generate information regarding abnormality on the window side in a case where the determination unit determines that abnormality occurs on the window side, and the display may be configured to display the information regarding abnormality on the object side or the information regarding abnormality on the window side. By visually recognizing the information regarding abnormality on the object side or the information regarding abnormality on the window side, the user can grasp whether a cause of occurrence of abnormality is on the object side or the window side.

A control method of a sensor unit according to one aspect of the present invention is a control method including an acquiring step of acquiring a signal from a sensor configured to measure a distance to an object by observing light reflected by the object and photoelectrically converts the light reflected by the object to output the signal, a determining step of determining whether or not a predetermined condition is satisfied based on rising of the signal and falling of the signal, a generating step of generating information regarding fluctuation in intensity of the light reflected by the object in a case where the predetermined condition is determined a predetermined number of times not to be satisfied, and a displaying step of displaying, on a display, the information regarding fluctuation in intensity of the light reflected by the object.

A non-transitory computer readable medium storing a program according to one aspect of the present invention is a program for causing a processor to execute an acquiring step of acquiring a signal from a sensor configured to measure a distance to an object by observing light reflected by the object and photoelectrically converts the light reflected by the object to output the signal, a determining step of determining whether or not a predetermined condition is satisfied based on rising of the signal and falling of the signal, a generating step of generating information regarding fluctuation in intensity of the light reflected by the object in a case where the predetermined condition is determined a predetermined number of times not to be satisfied, and a displaying step of displaying, on a display, the information regarding fluctuation in intensity of the light reflected by the object.

The present invention may be regarded as a sensor system having at least a part of the above means or functions, or may be regarded as a safety system or an FA system having the sensor system. Further, the present invention may be regarded as a control method of a sensor unit including at least a part of the above processing, or may be regarded as a detection method of a sensor unit. Furthermore, the present invention can also be regarded as a program for realizing such a method and a computer-readable recording medium in which the program is recorded non-temporarily. Note that each of the means and the processing can be combined with each other as much as possible to constitute the present invention.

According to the present invention, it is possible to provide a technique capable of grasping fluctuation in intensity of light reflected by an object.

### BRIEF DESCRIPTION OF THE DRAWINGS

FIG. 1 is a diagram illustrating a configuration of a sensor unit;

FIG. 2 is a block diagram of a sensor;

FIG. 3 is a diagram illustrating an example of a time chart of a signal;

FIG. 4 is a diagram illustrating a relationship between intensity of light reflected by a measurement target object and a width of a rectangular wave signal;

FIG. 5 is a diagram illustrating a relationship between intensity of light reflected by a measurement target object and a width of a rectangular wave signal;

FIG. 6 is a functional block diagram of a processor;

FIG. 7 is a schematic view of the sensor unit as viewed from the side surface side;

FIG. 8 is a diagram illustrating an example of installation of the sensor unit;

FIG. 9 is a diagram illustrating an example of installation of the sensor unit;

FIG. 10 is a schematic view of the sensor unit as viewed from the side surface side;

FIG. 11 is a schematic view of the sensor unit as viewed from the side surface side;

FIG. 12 is a schematic view of the sensor unit as viewed from the side surface side;

FIG. 13 is a flowchart illustrating an example of setting processing of reference point monitoring;

FIG. 14 is a flowchart illustrating an example of reference point monitoring processing;

FIG. 15 is a flowchart illustrating an example of abnormal position identifying processing;

FIG. 16 is a diagram illustrating an example of a screen of the display device;

FIG. 17 is a diagram illustrating an example of a screen of the display device; and

FIG. 18 is a diagram illustrating an example of setting of a stop area and a warning area.

### DETAILED DESCRIPTION

Hereinafter, an application example and an embodiment will be described with reference to the drawings. The application example and embodiment are one aspect of the present application, and do not limit the scope of rights of the present application.

### Application Example

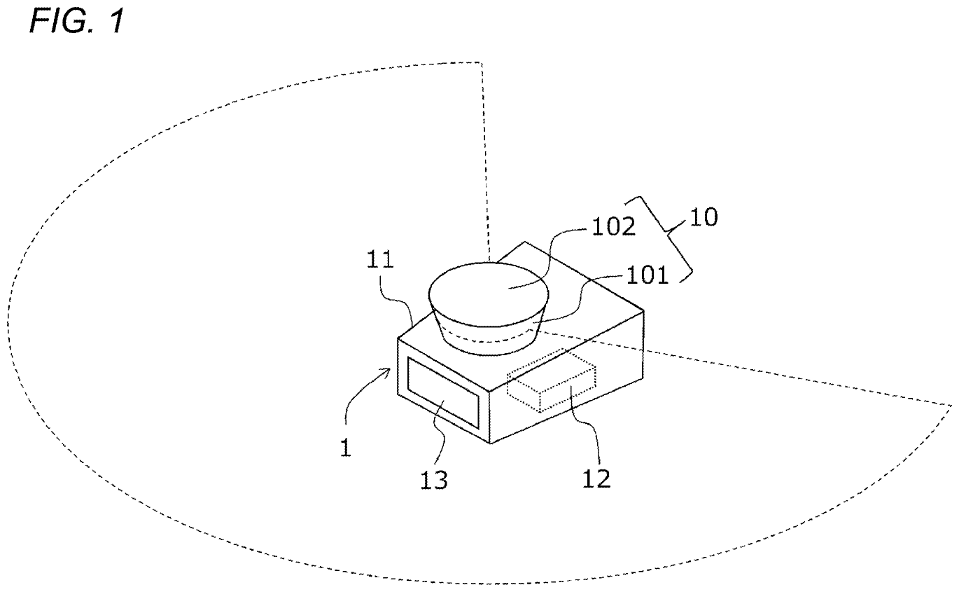

One application example of the present invention will be described with reference to FIGS. 1 to 3. FIG. 1 is a diagram illustrating a configuration of a sensor unit (sensor system) 1. The sensor unit 1 includes a sensor 10 of a reflective type, a main body 11, a processor 12 that performs predetermined processing, and a display device 13 capable of displaying predetermined information. The sensor unit 1 may have an integrated configuration in which the processor 12 and the display device 13 are provided in one casing, or may have a configuration in which the processor 12 and the display device 13 are separated and connected in a wired or wireless manner. In the configuration example illustrated in FIG. 1, the processor 12 is provided in the main body 11, and the display device 13 is provided on an outer surface of the main body 11. The display device 13 is an example of a display. In addition to the processor 12 and the display device 13, the main body 11 is provided with a light source, an optical system, a light receiving device, and the like that are a part of the sensor 10.

In the present specification, the “sensor of a reflective type” means a sensor capable of measuring a distance to an object by observing an electromagnetic wave reflected by the object, and includes, for example, a distance measuring sensor (LiDAR or the like) using laser light and a distance measuring sensor (millimeter wave radar or the like) using radio waves. An electromagnetic wave reflected by an object includes light. A measurement system of the sensor of a reflective type may be any system, and examples of the measurement system include a ToF system and a triangulation system. In order to measure objects in a plurality of directions, an area sensor having a two-dimensional measurement area (visual field) or a three-dimensional measurement area (visual field) is used.

The sensor unit 1 is also called a safety laser scanner or a laser scanner, and is a safety sensor conforming to a safety standard such as IS013849-1. The sensor 10 includes a window 101 and a top surface 102. The sensor 10 generally has a structure in which a window 101 having an inverted truncated cone shape is provided on the main body 11. The top surface 102 is provided on the window 101. The window 101 illustrated in FIG. 1 has a tapered shape expanding from one opening toward the other opening, but is not limited to this shape, and the window 101 may have a cylindrical shape.

The window 101 is transparent or translucent (colored with a predetermined transmittance), transmits a part of light, and reflects another part of light. The window 101 is made from a material that transmits laser light, and is a member for protecting an optical system such as a polygon mirror. Laser light output from a light source is reflected by a polygon mirror rotating at a high speed inside the window 101, so that the sensor 10 can scan a direction of about 270 degrees around. In this manner, the sensor 10 can measure a plurality of directions. That is, the sensor 10 can measure a distance to an object in a plurality of directions. Further, the sensor 10 measures a distance to an object at predetermined intervals (regular or irregular intervals). The processor 12 compares a distance to an object measured by the sensor 10 with a set predetermined distance, and performs predetermined processing on the basis of a comparison result.

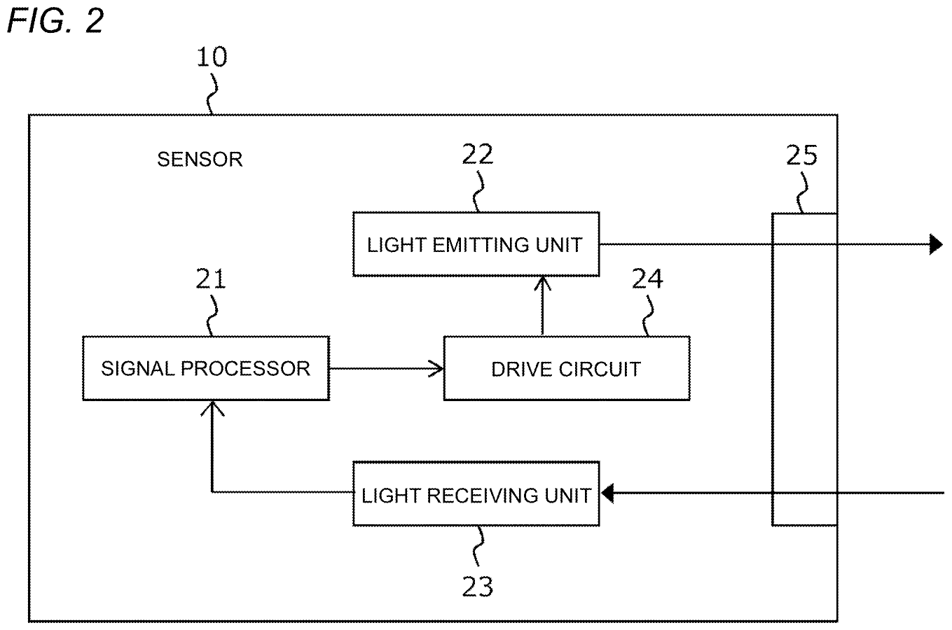

FIG. 2 is a block diagram of the sensor 10. The sensor 10 includes a signal processor 21, a light emitting unit (transmitter) 22, a light receiving unit (receiver) 23, and a drive circuit 24. The light emitting unit 22 is, for example, a laser diode. When the signal processor 21 controls the drive circuit 24, drive current is applied to the light emitting unit 22, and the light emitting unit 22 emits pulsed light to transmit an optical signal. When the light emitting unit 22 transmits an optical signal, light is emitted from the light emitting unit 22, and the light is emitted by passing through the window 101 to the outside via an optical component 25 such as a lens or a polygon mirror.

The light receiving unit 23 is, for example, a photodiode. Light emitted from the light emitting unit 22 to the outside and reflected by an object to be measured (hereinafter, also referred to as measurement target object or target) passes through the window 101 and is input as an optical signal to the light receiving unit 23 via the optical component 25. The light receiving unit 23 converts the optical signal into an electric signal according to intensity of the input optical signal and outputs the electric signal. The electric signal output from the light receiving unit 23 is input to the signal processor 21.

The signal processor 21 may measure a distance to a measurement target object by a ToF system. For example, the signal processor 21 measures a distance to a measurement target object on the basis of a time at which light is emitted, a time at which reflected light is received, and a speed of light. The signal processor 21 transmits measurement data to the processor 12. As described above, the sensor 10 measures a distance to a measurement target object when light emitted from the light emitting unit 22 passes through the window 101, is reflected by the measurement target object, passes through the window 101, and is received by the light receiving unit 23. The processor 12 acquires a distance to a measurement target object measured by the sensor 10.

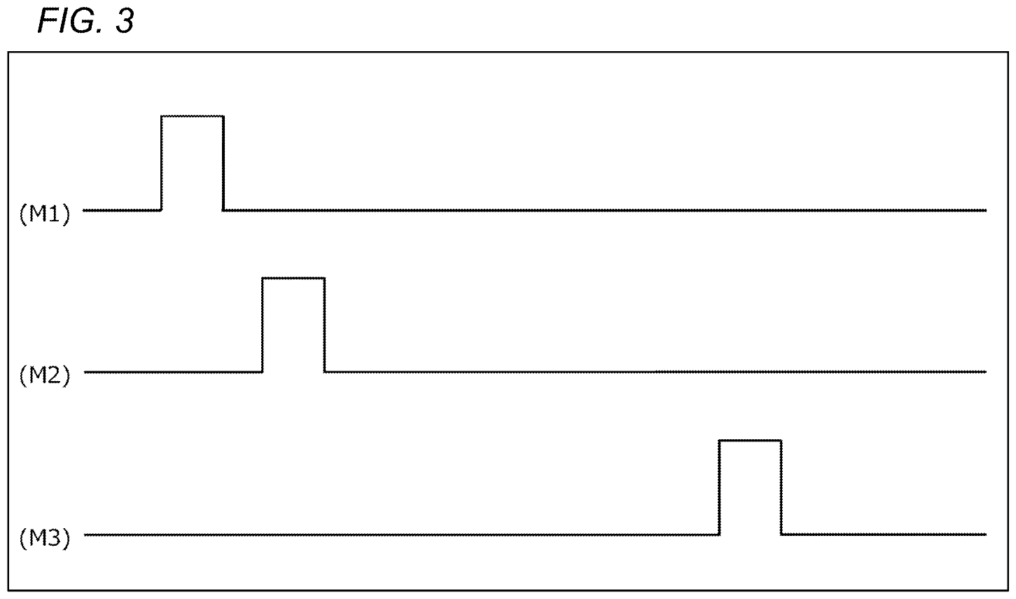

The signal processor 21 measures a distance to a measurement target object using an electric signal of a rectangular wave (pulse signal). FIG. 3 is a diagram illustrating an example of a time chart of a signal. A time chart (M1) of FIG. 3 illustrates a light emission (instruction) signal input from the drive circuit 24 to the light emitting unit 22. Time charts (M2) and (M3) of FIG. 3 illustrate waveforms in a case where an electric signal output from the light receiving unit 23 is formed into a rectangular wave. The time chart (M2) of FIG. 3 illustrates a waveform of an electric signal when emission light of the light emitting unit 22 is reflected by a reflective object provided inside the sensor 10 and the light receiving unit 23 receives the reflected light. The time chart (M3) of FIG. 3 illustrates a waveform of an electric signal when emission light of the light emitting unit 22 is emitted to the outside of the sensor 10, and the light receiving unit 23 receives the reflected light reflected by a measurement target object.

In a case where intensity of received light is equal to or more than a threshold, the light receiving unit 23 forms the received light into an electric signal of a rectangular wave (hereinafter referred to as a rectangular wave signal) and outputs the rectangular wave signal. For example, a timing at which intensity of received light becomes equal to or more than a threshold is a rising timing of a rectangular wave signal, and a timing at which intensity of received light becomes equal to or less than a threshold is a falling timing of a rectangular wave signal. Further, the light receiving unit 23 may output an electric signal corresponding to intensity of the received light, and the electric signal output from the light receiving unit 23 may be input to the signal processor 21. In a case where a value of an electric signal output from the light receiving unit 23 is equal to or more than a threshold, the signal processor 21 forms the electric signal output from the light receiving unit 23 into a rectangular wave and outputs the rectangular wave signal. For example, a timing at which an electrical signal output from the light receiving unit 23 becomes equal to or more than a threshold is a rising timing of a rectangular wave signal, and a timing at which an electrical signal output from the light receiving unit 23 becomes equal to or less than a threshold is a falling timing of a rectangular wave signal. In order to suppress influence of disturbance light or the like, a plurality of thresholds when the light receiving unit 23 performs photoelectric conversion may be prepared in advance. Further, selection may be made from a plurality of thresholds according to a measurement environment. Further, a threshold at rising of intensity of light and a threshold at falling of intensity of light may be different.

As a time at which light is emitted, a value obtained by correcting a rising time of the waveform in (M1) of FIG. 3 using a rising time of the waveform in (M2) of FIG. 3 is used. As a time at which reflected light is received, a rising time of the waveform in (M3) of FIG. 3 is used. As described above, the sensor 10 photoelectrically converts light reflected by a measurement target object and outputs a rectangular wave signal. The processor 12 acquires a rectangular wave signal output from the sensor 10. Further, the sensor 10 performs measurement in a plurality of directions to output a rectangular wave signal in a plurality of directions. The processor 12 acquires a rectangular wave signal in a plurality of directions output from the sensor 10.

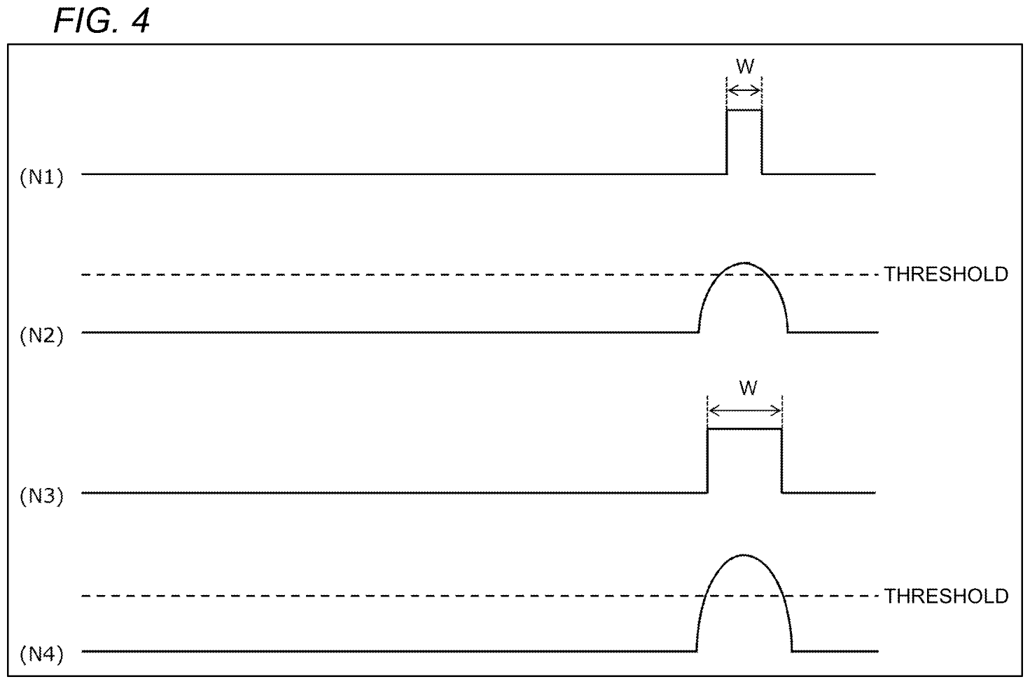

FIG. 4 is a diagram illustrating a relationship between intensity of light reflected by a measurement target object and a width (pulse width) of a rectangular wave signal. Charts (N1) and (N3) of FIG. 4 illustrate waveforms when light reflected by a measurement target object is photoelectrically converted into a rectangular wave signal. The chart (N2) in FIG. 4 illustrates intensity of light in (N1) in FIG. 4, and (N4) in FIG. 4 illustrates intensity of light in (N3) in FIG. 4. As illustrated in (N1) to (N4) of FIG. 4, when a peak value of intensity of light increases, a width (W) of a rectangular wave signal increases, and when a peak value of intensity of light decreases, the width (W) of a rectangular wave signal decreases. As described above, there is a correlation between intensity of light reflected by a measurement target object and a width of a rectangular wave signal, and it is possible to grasp fluctuation in intensity of light reflected by a measurement target object from a range of a width of a rectangular wave signal on the basis of such a correlation. Note that a rectangular wave signal means a signal until the signal falls from a Hi state to a Low state after the signal rises from the Low state to the Hi state. Further, the width (W) of a rectangular wave signal means a width from rising of a rectangular wave signal to falling of the rectangular wave signal.

In view of the above, in the sensor unit 1, the processor 12 acquires a rectangular wave signal and measures a width of the rectangular wave signal. The processor 12 detects a rising edge (rising timing) of a rectangular wave signal and a falling edge (falling timing) of the rectangular wave signal from the rectangular wave signal. The processor 12 measures a width of a rectangular wave signal on the basis of a rising edge of the rectangular wave signal and a falling edge of the rectangular wave signal. The processor 12 determines whether or not a width of a rectangular wave signal is equal to or more than a first predetermined width and equal to or less than a second predetermined width. In a case of determining a predetermined number of times that a width of a rectangular wave signal is not equal to or more than the first predetermined width and equal to or less than the second predetermined width, the processor 12 generates information regarding fluctuation in intensity of light reflected by a measurement target object (hereinafter referred to as fluctuation information of light intensity). The predetermined number of times can be set to any number of times, and may be once or a plurality of times.

The fluctuation information of light intensity is transmitted to the display device 13. The display device 13 displays the fluctuation information of light intensity. The fluctuation information of light intensity may include information indicating that intensity of light reflected by a measurement target object increases or information indicating that intensity of light reflected by a measurement target object decreases. By the user visually recognizing the fluctuation information of light intensity displayed on the display device 13, the user can grasp that intensity of light reflected by a measurement target object fluctuates.

For example, in a case where intensity of light reflected by a measurement target object fluctuates and the sensor unit 1 cannot monitor a reference point set to the measurement target object, a stop signal is output from the sensor unit 1 to an external device (external equipment). The external device is, for example, a device such as a robot or a press machine, but is not limited to these. By the user visually recognizing the fluctuation information of light intensity displayed on the display device 13, the user can grasp the fluctuation in intensity of light reflected by a measurement target object before an external device stops due to the fluctuation in the intensity of the light reflected by the measurement target object.

According to the sensor unit 1, it is possible to grasp fluctuation in intensity of light reflected by a measurement target object without conversion of the intensity of the light reflected by the measurement target object into an electric signal of an analog waveform. In a case where intensity of light reflected by a measurement target object is converted into an electric signal of an analog waveform, it is necessary to use a high-speed AD converter module. According to the sensor unit 1, it is possible to grasp intensity of light reflected by a measurement target object without mounting a high-speed AD converter module on the sensor 10 or the processor 12. Therefore, according to the sensor unit 1, cost reduction can be realized as compared with a laser scanner or the like mounted with a high-speed AD converter module.

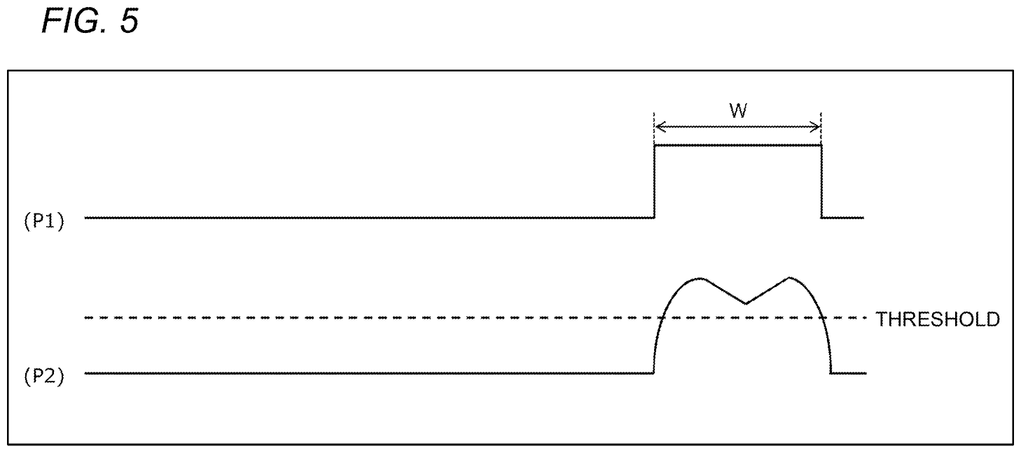

FIG. 5 is a diagram illustrating a relationship between intensity of light reflected by a measurement target object and a width of a rectangular wave signal. A chart (P1) in FIG. 5 illustrates a waveform when light reflected by a measurement target object is photoelectrically converted into a rectangular wave signal. A chart (P2) in FIG. 5 illustrates intensity of the light in (P1) in FIG. 5. For example, as illustrated in (P2) in FIG. 5, a peak value of intensity of light reflected by a measurement target object may occur twice due to influence of disturbance. Since a rectangular wave signal having a predetermined width as illustrated in (P1) of FIG. 5 or more is not normal, it is not preferable to perform determination of fluctuation in intensity of light reflected by a measurement target object (hereinafter referred to as fluctuation determination of light intensity) by using a width of the rectangular wave signal having the predetermined width or more.

In view of the above, the processor 12 may generate the fluctuation information of light intensity in a case where a width of a rectangular wave signal is determined twice or more continuously not to be included in a range of a predetermined width (for example, a range of the first predetermined width or more and the second predetermined width or less). By the above, for example, the fluctuation determination of light intensity can be more appropriately performed for the following cases:
Due to influence of disturbance, a rectangular wave signal in the first fluctuation determination of light intensity is not included in a range of a predetermined width; and
The influence of the disturbance is eliminated, and a rectangular wave signal in the second fluctuation determination of light intensity is included in the range of the predetermined width.

Since the rectangular wave signal in the second fluctuation determination of light intensity is included in the range of the predetermined width, the processor 12 does not generate the fluctuation information of light intensity.

Further, the light receiving unit 23 may photoelectrically convert received light and output an electrical signal having an analog waveform (hereinafter referred to as an analog waveform signal) corresponding to intensity of the light. The analog waveform signal output from the light receiving unit 23 is input to the signal processor 21. The signal processor 21 transmits an analog waveform signal to the processor 12. The processor 12 acquires an analog waveform signal. The processor 12 determines whether or not elapsed time from a timing at which rising of an analog waveform signal exceeds a first threshold to a timing at which falling of the analog waveform signal falls below a second threshold is equal to or more than first predetermined time and equal to or less than second predetermined time. In a case of determining a predetermined number of times that the elapsed time is not equal to or more than the first predetermined time and equal to or less than the second predetermined time, the processor 12 generates the fluctuation information of light intensity. The predetermined number of times can be set to any number of times, and may be once or a plurality of times.

As described above, the processor 12 acquires a signal (rectangular wave signal or analog waveform signal) from the signal processor 21. The processor 12 determines whether or not a predetermined condition is satisfied on the basis of rising of the signal and falling of the signal. In a case where the processor 12 acquires a rectangular wave signal, the predetermined condition is that a width of the rectangular wave signal, which is a width from rising of the rectangular wave signal to falling of the rectangular wave signal, is equal to or more than the first predetermined width and equal to or less than the second predetermined width. In a case where the processor 12 acquires an analog waveform signal, the predetermined condition is that elapsed time from a timing at which rising of the analog waveform signal exceeds the first threshold to a timing at which falling of the analog waveform signal falls below the second threshold is equal to or more than the first predetermined time and equal to or less than the second predetermined time.

### Embodiment

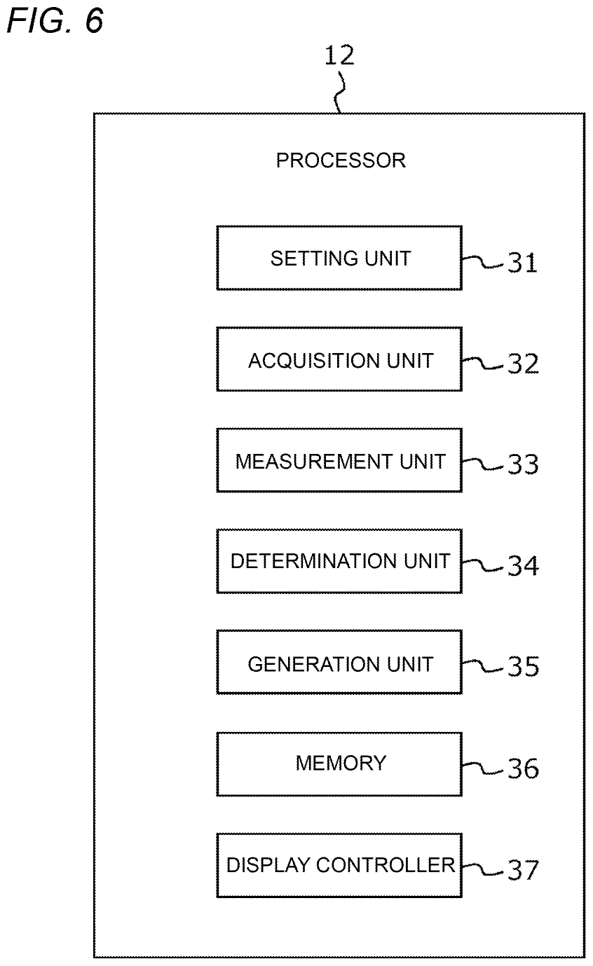

Hereinafter, an embodiment of the present invention will be described. FIG. 6 is a functional block diagram of the processor 12. The processor 12 includes a setting unit 31, an acquisition unit 32, a measurement unit 33, a determination unit 34, a generation unit 35, a memory 36, and a display controller 37 as main functions. Not all constituents of the processor 12 illustrated in FIG. 6 are essential, and the constituents of the processor 12 may be added or deleted as appropriate. For example, the processor 12 may include an output unit that outputs data and information generated by the generation unit 35. Further, the processor 12 may have a function as the signal processor 21.

The processor 12 is a device (controller) that controls the entire operation of the sensor unit 1 and controls the display device 13. The processor 12 acquires various types of data such as measurement data of a distance to a measurement target object measured by the sensor 10 from the sensor 10. The processor 12 may be configured by a dedicated device or a general-purpose computer. The processor 12 includes hardware resources such as a processor (CPU), a memory, a storage, and a communication I/F. The memory may be a RAM. The storage may be a non-volatile storage device (for example, ROM, flash memory, and the like). A function as each processor (functional unit) of the processor 12 is realized as a program stored in the storage is loaded into a memory and executed by the processor. Note that the configuration of the processor 12 is not limited to the above. For example, all or a part of the functions may be configured by a circuit such as ASIC or FPGA, or all or a part of the functions may be executed by a cloud server or another device.

The setting unit 31 performs various settings. The acquisition unit 32 acquires a rectangular wave signal from the sensor 10. Further, the acquisition unit 32 acquires an analog waveform signal from the sensor 10. The measurement unit 33 detects a rising edge and a falling edge of a rectangular wave signal from the rectangular wave signal, and measures a width of the rectangular wave signal on the basis of the rising edge and the falling edge of the rectangular wave signal. The width of the rectangular wave signal may be elapsed time (hereinafter referred to as elapsed time t) from a timing of the rising edge of the rectangular wave signal to a timing of the falling edge of the rectangular wave signal. The timing of the rising edge of the rectangular wave signal may be a timing at which the rising edge of the rectangular wave signal is detected. The timing of the falling edge of the rectangular wave signal may be a timing at which the falling edge of the rectangular wave signal is detected. Further, the “elapsed time t” may be applied to a “width of a rectangular wave signal” in each piece of processing below. The determination unit 34 determines whether a predetermined condition is satisfied based on rising of a rectangular wave signal and falling of the rectangular wave signal. The determination unit 34 may determine whether or not a width of a rectangular wave signal is equal to or more than the first predetermined width and equal to or less than the second predetermined width. In a case where a width of a rectangular wave signal is equal to or more than the first predetermined width and equal to or less than the second predetermined width, determination unit 34 determines that the predetermined condition is satisfied. The determination unit 34 may determine whether or not the elapsed time t is equal to or more than predetermined time t1 and equal to or less than predetermined time t2. In a case where the elapsed time t is equal to or more than the predetermined time t1 and equal to or less than the predetermined time t2, the determination unit 34 determines that the predetermined condition is satisfied. Further, the determination unit 34 may determine whether or not the predetermined condition is satisfied on the basis of rising of an analog waveform signal and falling of the analog waveform signal. The determination unit 34 may determine whether or not elapsed time (hereinafter referred to as elapsed time T) from a timing at which rising of an analog waveform signal exceeds the first threshold to a timing at which falling of the analog waveform signal falls below the second threshold is equal to or more than the first predetermined time and equal to or less than the second predetermined time. The first predetermined width, the second predetermined width, the predetermined time t1, the predetermined time t2, the first threshold, the second threshold, the first predetermined time, and the second predetermined time are obtained in advance by design, experiment, or simulation, and are stored in the memory 36. The first threshold and the second threshold may be the same value or different values. The first threshold and the second threshold may be corrected with a correction value according to a measurement environment. In a case where the elapsed time T is equal to or more than the first predetermined time and equal to or less than the second predetermined time, the determination unit 34 determines that the predetermined condition is satisfied.

In a case where the predetermined condition is determined a predetermined number of times not to be satisfied, the generation unit 35 generates the fluctuation information of light intensity. In a case where a width of a rectangular wave signal is determined a predetermined number of times not to be equal to or more than the first predetermined width and equal to or less than the second predetermined width, the generation unit 35 may generate the fluctuation information of light intensity. In a case where the elapsed time t is determined a predetermined number of times not to be equal to or more than the predetermined time t1 and equal to or less than the predetermined time t2, the generation unit 35 may generate the fluctuation information of light intensity. In a case where the elapsed time T is determined a predetermined number of times not to be equal to or more than the first predetermined time and equal to or less than the second predetermined time, the generation unit 35 may generate the fluctuation information of light intensity.

When an attachable matter adheres to a surface of a measurement target object, intensity of light reflected by the measurement target object may decrease or increase. Further, when an attachable matter adheres to a surface of the window 101, intensity of light reflected by the measurement target object may decrease or increase. Even if only fluctuation in intensity of light reflected by a measurement target object is observed, it is difficult to determine a cause of the fluctuation in intensity of the light reflected by the measurement target object, that is, whether the cause of occurrence of abnormality is on the measurement target object side or the window 101 side.

A case where the signal processor 21 outputs a rectangular wave signal will be described. In a case where light that is emitted from the light emitting unit 22, passes through the window 101, and is reflected by a measurement target object passes through the window 101 and is received by the light receiving unit 23, the signal processor 21 photoelectrically converts the light received by the light receiving unit 23 to output a first rectangular wave signal. The light receiving unit 23 may output the first rectangular wave signal. Further, in a case where light that is emitted from the light emitting unit 22 and reflected by the window 101 is received by the light receiving unit 23, the signal processor 21 photoelectrically converts the light received by the light receiving unit 23 to output a second rectangular wave signal. The light receiving unit 23 may output the second rectangular wave signal. The acquisition unit 32 acquires the first rectangular wave signal and the second rectangular wave signal. Since a time at which light reflected by a measurement target object is received by the light receiving unit 23 is different from a time at which light reflected by the window 101 is received by the light receiving unit 23, it is possible to distinguish between the first rectangular wave signal and the second rectangular wave signal. The measurement unit 33 measures a width of the first rectangular wave signal, which is a width from rising of the first rectangular wave signal to falling of the first rectangular wave signal. Further, the measurement unit 33 measures a width of the second rectangular wave signal, which is a width from rising of the second rectangular wave signal to falling of the second rectangular wave signal. The determination unit 34 determines whether abnormality occurs on the object side or the window 101 side based on the width of the first rectangular wave signal and the width of the second rectangular wave signal.

When an attachable matter adheres to a surface of a measurement target object, a width of the first rectangular wave signal changes as compared with a case where no attachable matter adheres to the surface of the measurement target object. For example, when oil or the like having a reflectance higher than that of a surface of a measurement target object adheres to the surface of the measurement target object, a width of the first rectangular wave signal increases as compared with a case where no attachable matter adheres to the surface of the measurement target object. For example, when sand or a chip having a reflectance lower than that of a surface of a measurement target object adheres to the surface of the measurement target object, a reflection direction of light changes, and a width of the first rectangular wave signal decreases as compared with a case where no attachable matter adheres to the surface of the measurement target object. For example, when a black adhesive substance or the like adheres to a surface of a measurement target object, a width of the first rectangular wave signal decreases as compared with a case where no attachable matter adheres to the surface of the measurement target object. When an attachable matter adheres to a surface of the window 101, a width of the first rectangular wave signal and a width of the second rectangular wave signal change as compared with a case where no attachable matter does not adhere to the surface of the window 101.

For example, in a case where a width of the first rectangular wave signal changes but a width of the second rectangular wave signal does not change, the determination unit 34 determines that a cause of the change in the width of the first rectangular wave signal, that is, a cause of occurrence of abnormality occurs on the measurement target object side. For example, in a case where a width of the first rectangular wave signal changes and a width of the second rectangular wave signal changes, the determination unit 34 determines that a cause of occurrence of abnormality occurs on the window 101 side. As described above, the determination unit 34 determines whether abnormality occurs on the measurement target object side or the window 101 side on the basis of a width of the first rectangular wave signal and a width of the second rectangular wave signal, so that it is possible to grasp whether a cause of occurrence of abnormality is on the measurement target object side or the window 101 side. By grasping whether a cause of occurrence of abnormality is on the measurement target object side or the window 101 side, it is possible to identify a position of the cause of the occurrence of the abnormality. That is, it is possible to identify whether the position of the cause of the occurrence of the abnormality is on the measurement target object side or the window 101 side.

In a case of determining a predetermined number of times that a width of the first rectangular wave signal is not equal to or more than the first predetermined width and equal to or less than the second predetermined width and that a width of the second rectangular wave signal is equal to or more than a third predetermined width and equal to or less than a fourth predetermined width, the determination unit 34 determines that abnormality occurs on the measurement target object side. For example, in a case where a width of the first rectangular wave signal changes but a width of the second rectangular wave signal does not change, a position of a cause of occurrence of abnormality is identified to be on the measurement target object side. When determining a predetermined number of times that a width of the first rectangular wave signal is not equal to or more than the first predetermined width and equal to or less than the second predetermined width and that a width of the second rectangular wave signal is not equal to or more than the third predetermined width and equal to or less than the fourth predetermined width, the determination unit 34 determines that abnormality occurs on the window 101 side. For example, in a case where a width of the first rectangular wave signal and a width of the second rectangular wave signal change, a position of a cause of occurrence of abnormality is determined to be on the window 101 side. The first predetermined width, the second predetermined width, the third predetermined width, and the fourth predetermined width are obtained in advance by design, experiment, or simulation, and are stored in the memory 36. The predetermined number of times can be set to any number of times, and may be once or a plurality of times.

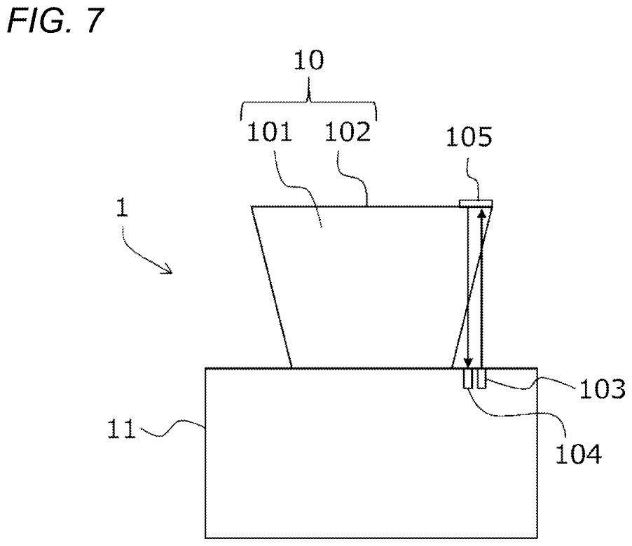

FIG. 7 is a schematic view of the sensor unit 1 in a case where the sensor unit 1 is viewed from the side surface side. The sensor unit 1 includes an emitter 103 that emits light, an optical receiver 104 that receives light, and a reflector 105 that reflects light. The emitter 103 is, for example, a laser diode or an LED. The optical receiver 104 is, for example, a photodiode. The reflector 105 is a plate-like member that reflects light.

In the configuration example illustrated in FIG. 7, the main body 11 is provided with the emitter 103 and the optical receiver 104, and the top surface 102 is provided with the reflector 105. Therefore, the emitter 103 and the optical receiver 104 are arranged below the window 101, and the reflector 105 is arranged above the window 101. The present invention is not limited to the configuration example illustrated in FIG. 7, and the reflector 105 may be provided in the main body 11, and the emitter 103 and the optical receiver 104 may be provided on the top surface 102. That is, the emitter 103 and the optical receiver 104 may be arranged above the window 101, and the reflector 105 may be arranged below the window 101. One of the emitter 103, one of the optical receiver 104, and one of the reflector 105 may be arranged. A plurality of the emitters 103, a plurality of the optical receivers 104, and a plurality of the reflectors 105 may be arranged at predetermined intervals along an outer periphery of the window 101.

The emitter 103, the optical receiver 104, and the reflector 105 are arranged such that a virtual line connecting the position of the emitter 103 and the position of the reflector 105 is inclined with respect to an outer peripheral surface of the window 101, and such that a virtual line connecting the position of the optical receiver 104 and the position of the reflector 105 is inclined with respect to the outer peripheral surface of the window 101. By the above, a part of light emitted from the emitter 103 passes through the window 101 and is reflected by the reflector 105, and the light reflected by the reflector 105 passes through the window 101 and is received by the optical receiver 104. Further, another part of the light emitted from the emitter 103 is reflected by the window 101, and the light reflected by the window 101 is received by the optical receiver 104.

The acquisition unit 32 acquires a light amount (hereinafter referred to as a first received light amount), which is an amount of light obtained when light that is emitted from the emitter 103, passes through the window 101, and is reflected by the reflector 105 and light that is emitted from the emitter 103 and reflected by the window 101 are received by the optical receiver 104. The acquisition unit 32 may acquire the first received light amount from the optical receiver 104. Further, the acquisition unit 32 may acquire the first received light amount via a control circuit that controls the emitter 103 and the optical receiver 104. The determination unit 34 determines whether abnormality occurs on the measurement target object side or the window 101 side based on a width of the first rectangular wave signal and the first received light amount.

When an attachable matter adheres to a surface of the window 101, a width of the first rectangular wave signal and the first received light amount change as compared with a case where no attachable matter adheres to the surface of the window 101. For example, in a case where a width of the first rectangular wave signal changes but the first received light amount does not decrease or increase, the determination unit 34 determines that a cause of occurrence of abnormality occurs on the measurement target object side. For example, in a case where a width of the first rectangular wave signal changes and the first received light amount decreases or increases, the determination unit 34 determines that a cause of occurrence of abnormality occurs on the window 101 side. As described above, the determination unit 34 determines whether abnormality occurs on the measurement target object side or the window 101 side on the basis of a width of the first rectangular wave signal and the first received light amount, so that it is possible to grasp whether a cause of occurrence of abnormality is on the measurement target object side or the window 101 side. By grasping whether a cause of occurrence of abnormality is on the measurement target object side or the window 101 side, it is possible to identify a position of the cause of the occurrence of the abnormality. That is, it is possible to identify whether the position of the cause of the occurrence of the abnormality is on the measurement target object side or the window 101 side.

In a case of determining a predetermined number of times that a width of the first rectangular wave signal is not equal to or more than the first predetermined width and equal to or less than the second predetermined width and that the first received light amount is included in a predetermined range (predetermined received light amount range), the determination unit 34 determines that abnormality occurs on the measurement target object side. For example, in a case where a width of the first rectangular wave signal changes but the first received light amount does not change, a position of a cause of occurrence of abnormality is identified to be on the measurement target object side. In a case of determining a predetermined number of times that a width of the first rectangular wave signal is not equal to or more than the first predetermined width and equal to or less than the second predetermined width and that the first received light amount is not included in the predetermined range, the determination unit 34 determines that abnormality occurs on the window 101 side. For example, in a case where a width of the first rectangular wave signal and the first received light amount change, a position of a cause of occurrence of abnormality is determined to be on the window 101 side. The predetermined range is obtained in advance by design, experiment, or simulation, and is stored in the memory 36. The predetermined number of times can be set to any number of times, and may be once or a plurality of times.

As described above, the determination unit 34 performs first abnormality determination for determining whether abnormality occurs on the measurement target object side or the window 101 side based on a width of the first rectangular wave signal and a width of the second rectangular wave signal. Further, the determination unit 34 performs second abnormality determination for determining whether abnormality occurs on the measurement target object side or the window 101 side based on a width of the first rectangular wave signal and the first received light amount. The determination unit 34 may perform at least one of the first abnormality determination and the second abnormality determination. In a case where the determination unit 34 performs the first abnormality determination and does not perform the second abnormality determination, installation of the emitter 103, the optical receiver 104, and the reflector 105 in the sensor unit 1 can be omitted.

A case where the signal processor 21 outputs an analog waveform signal will be described. In a case where light that is emitted from the light emitting unit 22, passes through the window 101, and is reflected by a measurement target object passes through the window 101 and is received by the light receiving unit 23, the signal processor 21 photoelectrically converts the light received by the light receiving unit 23 to output a first analog waveform signal. The light receiving unit 23 may output the first analog waveform signal. Further, in a case where light that is emitted from the light emitting unit 22 and reflected by the window 101 is received by the light receiving unit 23, the signal processor 21 photoelectrically converts the light received by the light receiving unit 23 to output a second analog waveform signal. The light receiving unit 23 may output the second analog waveform signal. The acquisition unit 32 acquires the first analog waveform signal and the second analog waveform signal. Since a time at which light reflected by a measurement target object is received by the light receiving unit 23 is different from a time at which light reflected by the window 101 is received by the light receiving unit 23, it is possible to distinguish between the first analog waveform signal and the second analog waveform signal. The measurement unit 33 measures elapsed time (hereinafter referred to as elapsed time T1) from a timing at which rising of the first analog waveform signal exceeds the first threshold to a timing at which falling of the first analog waveform signal falls below the second threshold. The elapsed time T1 is an example of first elapsed time. Further, the measurement unit 33 measures elapsed time (hereinafter referred to as elapsed time T2) from a timing at which rising of the second analog waveform signal exceeds a third threshold to a timing at which falling of the second analog waveform signal falls below a fourth threshold. The elapsed time T2 is an example of second elapsed time. The third threshold and the fourth threshold are obtained in advance by design, experiment, or simulation, and stored in the memory 36. The third threshold and the fourth threshold may be the same value or different values. The third threshold and the fourth threshold may be corrected with a correction value according to a measurement environment. The determination unit 34 determines whether abnormality occurs on the object side or the window 101 side based on the elapsed time T1 and the elapsed time T2.

When an attachable matter adheres to a surface of a measurement object, the elapsed time T1 changes as compared with a case where no attachable matter adheres to the surface of the measurement object. When an attachable matter adheres to a surface of the window 101, the elapsed time T1 and the elapsed time T2 change as compared with a case where no attachable matter adheres to the surface of the window 101. For example, in a case where the elapsed time T1 changes but the elapsed time T2 does not change, the determination unit 34 determines that a cause of the change in the elapsed time T1, that is, a cause of occurrence of abnormality occurs on the measurement target object side. For example, in a case where the elapsed time T1 changes and the elapsed time T2 changes, the determination unit 34 determines that a cause of occurrence of abnormality occurs on the window 101 side. As described above, the determination unit 34 determines whether abnormality occurs on the measurement target object side or the window 101 side on the basis of the elapsed time T1 and the elapsed time T2, so that it is possible to grasp whether a cause of occurrence of abnormality is on the measurement target object side or the window 101 side.

In a case of determining a predetermined number of times that the elapsed time T1 is not equal to or more than the first predetermined time and equal to or less than the second predetermined time and that the elapsed time T2 is equal to or more than third predetermined time and equal to or less than fourth predetermined time, the determination unit 34 determines that abnormality occurs on the measurement target object side. For example, in a case where the elapsed time T1 changes but the elapsed time T2 does not change, a position of a cause of occurrence of abnormality is identified to be on the measurement target object side. In a case of determining a predetermined number of times that the elapsed time T1 is not equal to or more than the first predetermined time and equal to or less than the second predetermined time and that the elapsed time T2 is not equal to or more than the third predetermined time and equal to or less than the fourth predetermined time, the determination unit 34 determines that abnormality occurs on the window 101 side. For example, in a case where the elapsed time T1 and the elapsed time T2 change, a position of a cause of occurrence of abnormality is determined to be on the window 101 side. The first predetermined time, the second predetermined time, the third predetermined time, and the fourth predetermined time are obtained in advance by design, experiment, or simulation, and stored in the memory 36. The predetermined number of times can be set to any number of times, and may be once or a plurality of times.

The determination unit 34 determines whether abnormality occurs on the measurement target object side or the window 101 side based on the elapsed time T1 and the first received light amount. When an attachable matter adheres to a surface of the window 101, the elapsed time T1 and the first received light amount change as compared with a case where no attachable matter adheres to the surface of the window 101. For example, in a case where the elapsed time T1 changes but the first received light amount does not decrease or increase, the determination unit 34 determines that a cause of occurrence of abnormality occurs on the measurement target object side. For example, in a case where the elapsed time T1 changes and the first received light amount decreases or increases, the determination unit 34 determines that a cause of occurrence of abnormality occurs on the window 101 side. As described above, the determination unit 34 determines whether abnormality occurs on the measurement target object side or the window 101 side on the basis of the elapsed time T1 and the first received light amount, so that it is possible to grasp whether a cause of occurrence of abnormality is on the measurement target object side or the window 101 side.

In a case of determining a predetermined number of times that the elapsed time T1 is not equal to or more than the first predetermined time and equal to or less than the second predetermined time and that the first received light amount is included in the predetermined range, the determination unit 34 determines that abnormality occurs on the measurement target object side. For example, in a case where the elapsed time T1 changes but the first received light amount does not change, a position of a cause of occurrence of abnormality is identified to be on the measurement target object side. In a case of determining a predetermined number of times that the elapsed time T1 is not equal to or more than the first predetermined time and equal to or less than the second predetermined time and that the first received light amount is not included in the predetermined range, the determination unit 34 determines that abnormality occurs on the window 101 side. For example, in a case where the elapsed time T1 and the first received light amount change, a position of a cause of occurrence of abnormality is determined to be on the window 101 side. The predetermined number of times can be set to any number of times, and may be once or a plurality of times.

As described above, the determination unit 34 performs third abnormality determination for determining whether abnormality occurs on the measurement target object side or the window 101 side based on the elapsed time T1 and the elapsed time T2. Further, the determination unit 34 performs fourth abnormality determination for determining whether abnormality occurs on the measurement target object side or the window 101 side based on the elapsed time T1 and the first received light amount. The determination unit 34 may perform at least one of the third abnormality determination and the fourth abnormality determination. In a case where the determination unit 34 performs the third abnormality determination and does not perform the fourth abnormality determination, installation of the emitter 103, the optical receiver 104, and the reflector 105 in the sensor unit 1 can be omitted.

In a case where the determination unit 34 determines that abnormality occurs on the measurement target object side, the generation unit 35 generates information (hereinafter referred to as target abnormality information) on the abnormality on the measurement target object side. The target abnormality information may include at least one of (1) information indicating a possibility that an attachable matter is attached to a target, (2) information prompting the user to check a surface of the target, and (3) information prompting the user to clean the surface of the target. The target abnormality information may include information regarding fluctuation in intensity of light reflected by a measurement target object in addition to the information of (1) to (3). The information regarding fluctuation in intensity of light reflected by a measurement target object is, for example, information indicating that intensity of light reflected by a measurement target object increases or information indicating that intensity of light reflected by a measurement target object decreases.

In a case where the determination unit 34 determines that abnormality occurs in the window 101, the generation unit 35 generates information regarding abnormality on the window 101 side (hereinafter referred to as window abnormality information). The window abnormality information may include at least one of (4) information indicating a possibility that an attachable matter is attached to the window 101, (5) information prompting the user to check a surface of the window 101, and (6) information prompting the user to clean the surface of the window 101. The window abnormality information may include the information regarding fluctuation in intensity of light reflected by a measurement target object and information regarding fluctuation in intensity of light reflected by the window 101 in addition to the information of (4) to (6). The information regarding fluctuation in intensity of light reflected by the window 101 is, for example, information indicating that intensity of light reflected by the window 101 increases or information indicating that intensity of light reflected by the window 101 decreases. The window abnormality information may include the information regarding fluctuation in intensity of light reflected by a measurement target object and information regarding fluctuation in the first received light amount in addition to the information of (4) to (6). The information regarding fluctuation in the first received light amount is, for example, information indicating that the first received light amount increases or information indicating that the first received light amount decreases.

The memory 36 stores various types of data and information. The memory 36 may include a RAM, a non-volatile storage device (for example, ROM, flash memory, and the like), and the like. The display controller 37 controls the display device 13 on the basis of information generated by the generation unit 35. The display controller 37 controls the display device 13 on the basis of the target abnormality information generated by the generation unit 35, so that the display device 13 displays the target abnormality information. By the user visually recognizing the target abnormality information displayed on the display device 13, the user can grasp that a cause of occurrence of abnormality is on the measurement target object side, and can identify a position of the cause of the occurrence of the abnormality.

The display controller 37 controls the display device 13 on the basis of the window abnormality information generated by the generation unit 35, so that the display device 13 displays the window abnormality information. By the user visually recognizing the window abnormality information displayed on the display device 13, the user can grasp that a cause of occurrence of abnormality is on the window 101 side, and can identify a position of the cause of the occurrence of the abnormality.

The display device 13 is a device that displays various types of data and information. The display device 13 is, for example, a liquid crystal display, an organic electro luminescence (EL) display, an indicating lamp, or the like. Further, the sensor unit 1 may include an input device such as an operation button and a touch panel. The touch panel may be integrated with the display device 13. The display device 13 may have at least one of a display having a screen for displaying data and information and an indicating lamp for displaying information by changing a glimmering pattern or a blinking pattern.

The acquisition unit 32 may acquire a rectangular wave signal in a plurality of directions. The acquisition unit 32 may acquire the first rectangular wave signal and the second rectangular wave signal in a plurality of directions. The determination unit 34 may determine whether or not the predetermined condition is satisfied based on rising of a rectangular wave signal and falling of the rectangular wave signal in at least one of a plurality of directions. The acquisition unit 32 may acquire an analog waveform signal in a plurality of directions. The acquisition unit 32 may acquire the first analog waveform signal and the second analog waveform signal in a plurality of directions. The determination unit 34 may determine whether or not the predetermined condition is satisfied on the basis of rising of an analog waveform signal and falling of the analog waveform signal in at least one of a plurality of directions. In a case where the predetermined condition is determined a predetermined number of times not to be satisfied in at least one of a plurality of directions, the generation unit 35 may generate the fluctuation information of light intensity.

The measurement unit 33 may measure a width of a rectangular wave signal in a plurality of directions. The determination unit 34 may determine whether or not a width of a rectangular wave signal in a plurality of directions is equal to or more than the first predetermined width and equal to or less than the second predetermined width. In a case where a width of a rectangular wave signal in at least one of a plurality of directions is determined a predetermined number of times not to be equal to or more than the first predetermined width and equal to or less than the second predetermined width, the generation unit 35 may generate the fluctuation information of light intensity. In a case where a width of a rectangular wave signal in at least two or more of a plurality of directions is determined a predetermined number of times not to be equal to or more than the first predetermined width and equal to or less than the second predetermined width, the generation unit 35 may generate the fluctuation information of light intensity. By the above, it is possible to grasp fluctuation in intensity of light reflected by a measurement target object on the basis of a width of a rectangular wave signal in a plurality of directions.

The determination unit 34 may determine whether abnormality occurs on the measurement target object side or the window 101 side based on a width of the first rectangular wave signal in a plurality of directions and a width of the second rectangular wave signal in a plurality of directions. By the above, a position of a cause of occurrence of abnormality can be identified based on a width of the first rectangular wave signal in a plurality of directions and a width of the second rectangular wave signal in a plurality of directions.

The acquisition unit 32 may acquire the first received light amount in a plurality of directions. With a plurality of the emitters 103, a plurality of the optical receivers 104, and a plurality of the reflectors 105 arranged along an outer periphery of the window 101, the acquisition unit 32 can acquire the first received light amount in a plurality of directions. The determination unit 34 may determine whether abnormality occurs on the measurement target object side or the window 101 side based on a width of the first rectangular wave signal in a plurality of directions and the first received light amount in a plurality of directions. By the above, a position of a cause of occurrence of abnormality can be identified based on a width of the first rectangular wave signal in a plurality of directions and the first received light amount in a plurality of directions.

The measurement unit 33 may measure the elapsed time T1 and the elapsed time T2 in a plurality of directions. The determination unit 34 may determine whether or not the elapsed time T1 in a plurality of directions is equal to or more than the first predetermined time and equal to or less than the second predetermined time. The determination unit 34 may determine whether or not the elapsed time T2 in a plurality of directions is equal to or more than the third predetermined time and equal to or less than the fourth predetermined time. In a case where the elapsed time T1 in at least one of a plurality of directions is determined a predetermined number of times not to be equal to or more than the first predetermined time and equal to or less than the second predetermined time, the generation unit 35 may generate the fluctuation information of light intensity. In a case where the elapsed time T1 in two or more of a plurality of directions is determined a predetermined number of times not to be equal to or more than the first predetermined time and equal to or less than the second predetermined time, the generation unit 35 may generate the fluctuation information of light intensity. By the above, it is possible to grasp fluctuation in intensity of light reflected by a measurement target object on the basis of the elapsed time T1 in a plurality of directions.

The determination unit 34 may determine whether abnormality occurs on the measurement target object side or the window 101 side based on the elapsed time T1 in a plurality of directions and the elapsed time T2 in a plurality of directions. By the above, a position of a cause of occurrence of abnormality can be identified based on the elapsed time T1 in a plurality of directions and the elapsed time T2 in a plurality of directions.

The determination unit 34 may determine whether abnormality occurs on the measurement target object side or the window 101 side based on the elapsed time T1 in a plurality of directions and the first received light amount in a plurality of directions. By the above, a position of a cause of occurrence of abnormality can be identified based on the elapsed time T1 in a plurality of directions and the first received light amount in a plurality of directions.

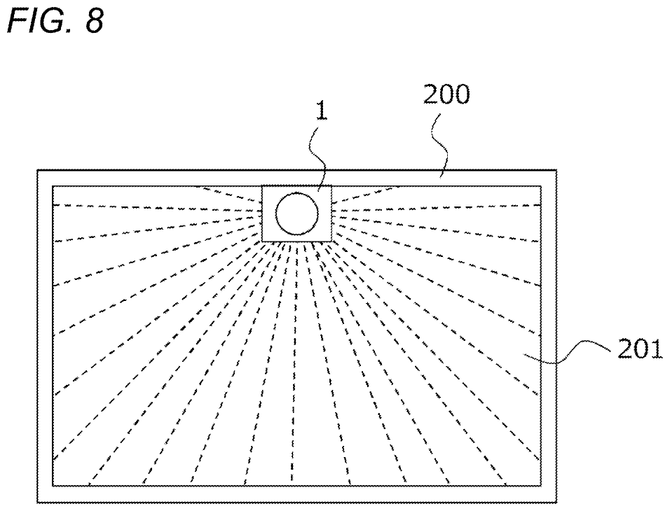

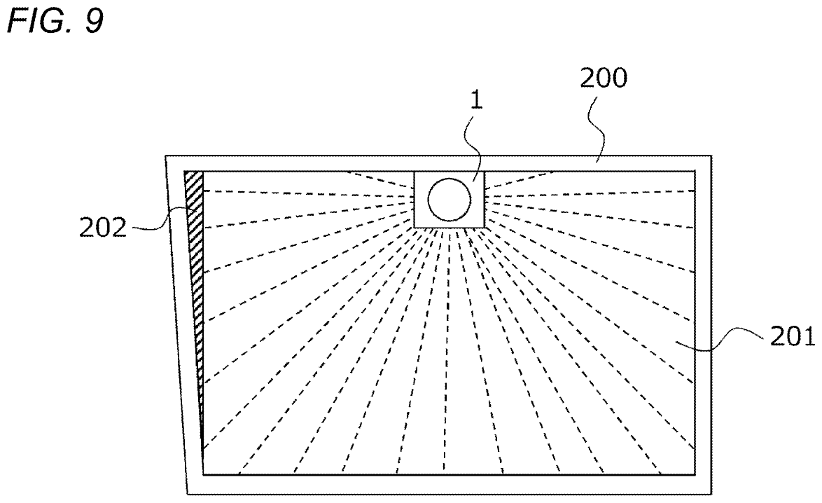

FIG. 8 is a diagram illustrating an example of installation of the sensor unit 1. In the example illustrated in FIG. 8, the sensor unit 1 is provided in a frame 200, and a monitoring area 201 is set inside the frame 200. The monitoring area 201 is an area set using each predetermined point of the frame 200 as a reference point. The sensor unit 1 constantly monitors the monitoring area 201. When a person or an object enters the monitoring area 201, the sensor unit 1 outputs a stop signal to an external device. Further, as illustrated in FIG. 9, there is a case where positional displacement of the frame 200 occurs due to inclination of the frame 200, and a gap 202 is generated between the frame 200 and the monitoring area 201. In a case where a reference point monitoring function is enabled, a stop signal is output from the sensor unit 1 to an external device. When an external device suddenly stops due to generation of the gap 202 between the frame 200 and the monitoring area 201, work is interrupted and work efficiency is lowered.

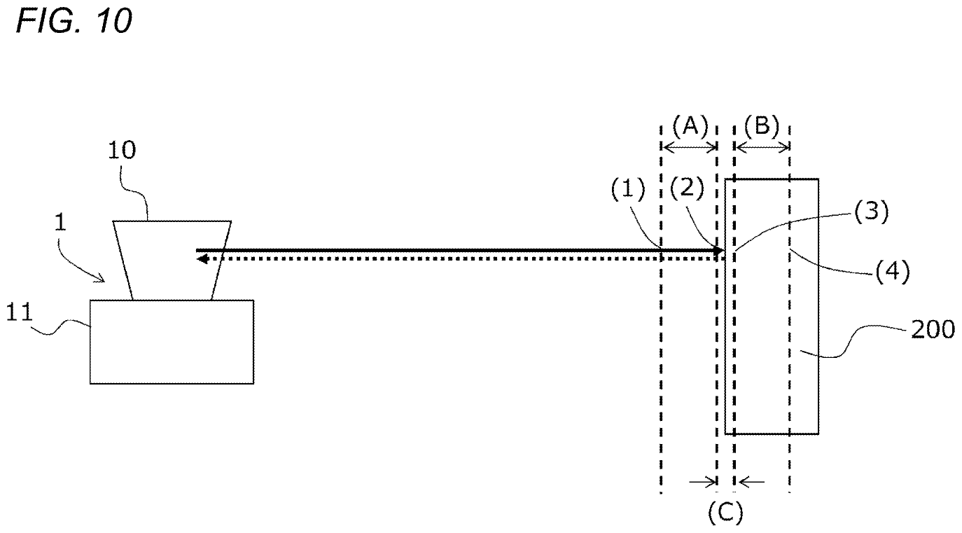

In view of the above, in the sensor unit 1, the processor 12 may detect positional displacement of a measurement target object, and the display device 13 may display the positional displacement of the measurement target object, so that the user can grasp the positional displacement of the measurement target object before an external device stops. Hereinafter, an example of detecting positional displacement of a measurement target object will be described with reference to FIGS. 10 to 12.

FIGS. 10 to 12 are schematic diagrams when the sensor unit 1 is viewed from the side surface side. The determination unit 34 performs first determination to determine whether or not a distance to a measurement target object is included in a first distance range from a first predetermined distance to a second predetermined distance longer than the first predetermined distance. In FIGS. 10 to 12, a distance (hereinafter referred to as distance L1) from the position of the sensor 10 to a predetermined position (1) is an example of the first predetermined distance. In FIGS. 10 to 12, a distance (hereinafter referred to as distance L2) from the position of the sensor 10 to a predetermined position (2) is an example of the second predetermined distance. In FIGS. 10 to 12, a range (A) from the distance L1 to the distance L2 is an example of the first distance range. The determination unit 34 determines whether or not a distance to the frame 200 is included in the range (A) from the distance L1 to the distance L2. That is, the determination unit 34 determines whether or not the position of the frame 200 is included in the range (A) from the predetermined position (1) to the predetermined position (2). The position of the frame 200 is the position of an object to be measured by the sensor unit 1.

Furthermore, the determination unit 34 performs second determination to determine whether or not a distance to a measurement target object is included in a second distance range from a third predetermined distance to a fourth predetermined distance longer than the third predetermined distance. In FIGS. 10 to 12, a distance (hereinafter referred to as distance L3) from the position of the sensor 10 to a predetermined position (3) is an example of the third predetermined distance. In FIGS. 10 to 12, a distance (hereinafter referred to as distance L4) from the position of the sensor 10 to a predetermined position (4) is an example of the fourth predetermined distance. In FIGS. 10 to 12, a range (B) from the distance L3 to the distance L4 is an example of the second distance range. The determination unit 34 determines whether or not a distance to the frame 200 is included in the range (B) from the distance L3 to the distance L4. That is, the determination unit 34 determines whether or not the position of the frame 200 is included in the range (B) from the predetermined position (3) to the predetermined position (4).

The determination unit 34 performs at least one of the first determination and the second determination. In a case where a distance to a measurement target object is determined a predetermined number of times to be included in the first distance range or in a case where the distance to the measurement target object is determined a predetermined number of times to be included in the second distance range, the determination unit 34 generates information regarding positional displacement of the object. The predetermined number of times can be set to any number of times, and may be once or a plurality of times.

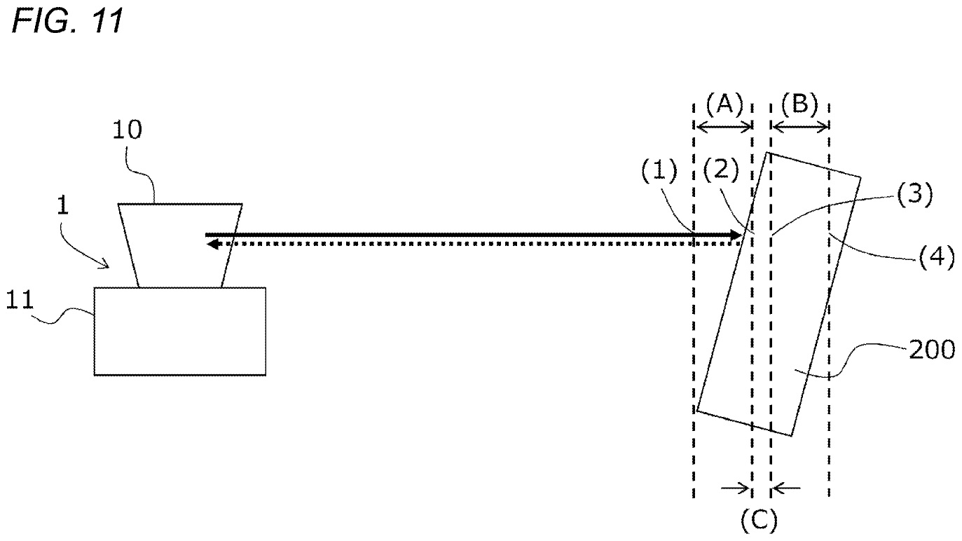

In FIG. 11, inclination of the frame 200 causes positional displacement of the frame 200, and the position of the frame 200 is included in the range (A) from the predetermined position (1) to the predetermined position (2). For this reason, the distance to the frame 200 is determined to be included in the range (A) from the distance L1 to the distance L2, and the generation unit 35 generates information regarding positional displacement of a measurement target object.

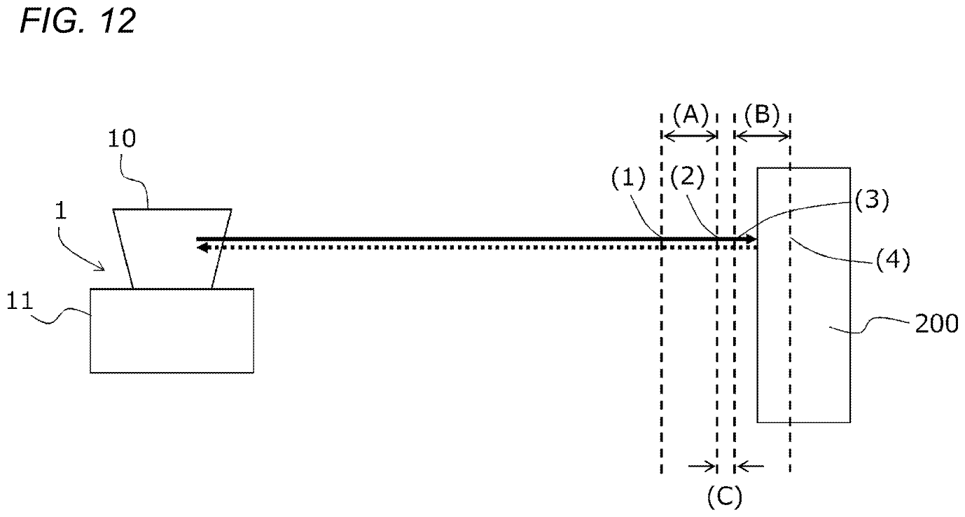

In FIG. 12, as the frame 200 moves, positional displacement of the frame 200 occurs, and the position of the frame 200 is included in the range (B) from the predetermined position (3) to the predetermined position (4). For this reason, the distance to the frame 200 is determined to be included in the range (B) from the distance L3 to the distance L4, and the generation unit 35 generates information regarding positional displacement of a measurement target object.

The display controller 37 controls the display device 13 on the basis of information regarding positional displacement of a measurement target object generated by the generation unit 35, so that the display device 13 displays the information regarding the positional displacement of the measurement target object. The information regarding positional displacement of a measurement target object may include information indicating that the position of a measurement target object is displaced. The information regarding positional displacement of a measurement target object may include information prompting the user to check an installation state of the measurement target object. When the user visually recognizes the information regarding positional displacement of a measurement target object displayed on the display device 13, the user can grasp the positional displacement of the measurement target object before an external device stops. As described above, according to the sensor unit 1, it is possible to grasp positional displacement of a measurement target object before an external device stops due to the positional displacement of the measurement target object.

The determination unit 34 performs third determination to determine whether or not a distance to a measurement target object is included in a third distance range from the second predetermined distance to the third predetermined distance. In FIGS. 10 to 12, a range (C) from the distance L2 to the distance L3 is an example of the third distance range. The determination unit 34 determines whether or not a distance to the frame 200 is included in the range (C) from the distance L2 to the distance L3. That is, the determination unit 34 determines whether or not the position of the frame 200 is included in the range (C) from the predetermined position (2) to the predetermined position (3). In a case where a distance to a measurement target object is determined a predetermined number of times to be included in the third distance range, the determination unit 34 does not generate the information regarding positional displacement of a measurement target object. The predetermined number of times can be set to any number of times, and may be once or a plurality of times.

Further, the determination unit 34 performs at least one of fourth determination of determining whether or not a distance to a measurement target object is shorter than the first predetermined distance and fifth determination of determining whether or not the distance to the measurement target object is longer than the fourth predetermined distance. In a case where a distance to a measurement target object is determined a predetermined number of times to be shorter than the first predetermined distance or in a case where the distance to the measurement target object is determined a predetermined number of times to be longer than the fourth predetermined distance, the generation unit 35 generates a stop signal for stopping an external device and sends the stop signal to the external device. The predetermined number of times can be set to any number of times, and may be once or a plurality of times. In a case where a distance to a measurement target object is shorter than the first predetermined distance or in a case where a distance to a measurement target object is longer than the fourth predetermined distance, since positional displacement of the measurement target object exceeds an allowable range, the generation unit 35 sends a stop signal to an external device. As described above, in a case where positional displacement of a measurement target object exceeds an allowable range, an external device can be stopped.

A setting tool (software program) of the sensor unit 1 is installed in a general personal computer, and the user can set an allowable range to the sensor unit 1 using the setting tool.

As described above, the sensor 10 can measure a plurality of directions. A distance to a measurement target object differs for each of a plurality of directions. For this reason, the determination unit 34 compares a distance to a measurement target object with the first predetermined distance, the second predetermined distance, the third predetermined distance, and the fourth predetermined distance set for each of a plurality of directions.

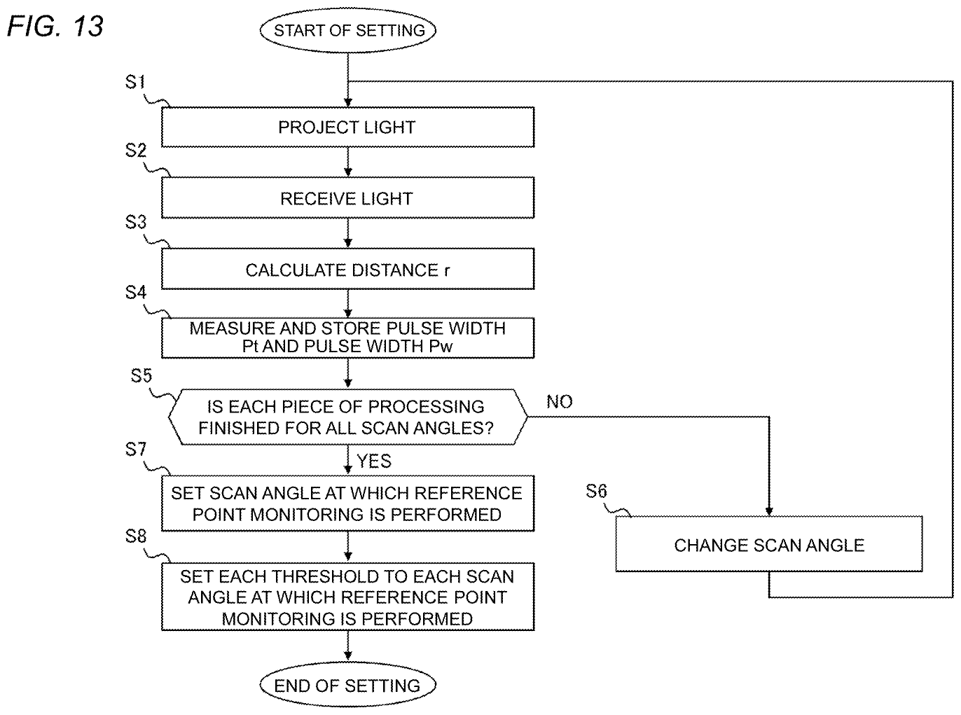

FIG. 13 is a flowchart illustrating an example of setting processing of reference point monitoring. For example, in a case where the sensor unit 1 is arranged for the first time or in a case where arrangement of the sensor unit 1 is changed, the setting processing is performed. Further, the setting processing of the reference point monitoring is performed in a state where a surface of a measurement target object and a surface of the window 101 are cleaned. In S1, a predetermined scan angle is set, and the light emitting unit 22 emits (projects) light. In S2, the light receiving unit 23 receives light reflected by a measurement target object and light reflected by the window 101. In S3, the signal processor 21 calculates a distance (hereinafter referred to as distance R) to the measurement target object and stores the distance R in the memory 36. In S4, the acquisition unit 32 acquires, from the sensor 10, a rectangular wave signal obtained by photoelectrical conversion of light reflected by the measurement target object and a rectangular wave signal obtained by photoelectrical conversion of light reflected by the window 101. In S4, the measurement unit 33 measures a width (hereinafter referred to as pulse width Pt) of the rectangular wave signal obtained by photoelectrical conversion of the light reflected by the measurement target object, and stores the pulse width Pt in the memory 36. In S4, the measurement unit 33 measures a width (hereinafter referred to as pulse width Pw) of the rectangular wave signal obtained by photoelectrical conversion of the light reflected by the window 101, and stores the pulse width Pw in the memory 36.

In S5, the setting unit 31 determines whether the calculation processing and the storing processing for the distance R and the measurement processing and the storing processing for the pulse widths Pt and Pw are completed for all scan angles. In a case where each piece of the processing is not completed for all scan angles (S5; NO), the processing proceeds to S6, and the setting unit 31 changes the scan angle. As each piece of the processing of S1 to S4 is executed, the sensor 10 can measure a plurality of directions. In S7, the setting unit 31 sets a scan angle at which the reference point monitoring is performed. That is, the setting unit 31 sets a range (area) for detecting fluctuation in a width of a rectangular wave signal and positional displacement of a measurement target object.

In S8, the setting unit 31 sets each threshold for each scan angle at which the reference point monitoring is performed. Specifically, the setting unit 31 sets a threshold (R−A, R+A) of a distance for the reference point monitoring, a threshold (R−B, R+B) of a distance at which a stable monitoring can be performed, a threshold (Pt−Pt′, Pt+Pt′), and a threshold (Pw−Pw′, Pw+Pw′). The threshold (R−A, R+A) is a threshold used when whether or not positional displacement of a measurement target object exceeds an allowable range is determined. The threshold (R−B, R+B) is a threshold used to detect positional displacement of a measurement target object. The threshold (R−A) is a value smaller than the threshold (R−B). The threshold (R+A) is a value larger than the threshold (R+B). The threshold (Pt−Pt′, Pt+Pt′) is a threshold used to detect fluctuation in a width of the first rectangular wave signal. The threshold (Pw−Pw′, Pw+Pw′) is a threshold used to detect fluctuation in a width of the second rectangular wave signal.

The threshold (R−A, R+A), the threshold (R−B, R+B), the threshold (Pt−Pt′, Pt+Pt′), and the threshold (Pw−Pw′, Pw+Pw′) may be obtained by design, experiment, or simulation. A method of setting each value of (A), (B), (Pt′), and (Pw′) in the threshold (R−A, R+A), the threshold (R−B, R+B), the threshold (Pt−Pt′, Pt+Pt′), and the threshold (Pw−Pw′, Pw+Pw′) is not limited. Each value of (A), (B), (Ct′), and (Cw′) in each threshold may be, for example, a constant or may vary depending on an algorithm. Further, another threshold (for example, a lower limit Ab and an upper limit At) may be further set with respect to an upper limit and a lower limit of the threshold (R−A, R+A), the threshold (R−B, R+B), the threshold (Pt−Pt′, Pt+Pt′), and the threshold (Pw−Pw′, Pw+Pw′).

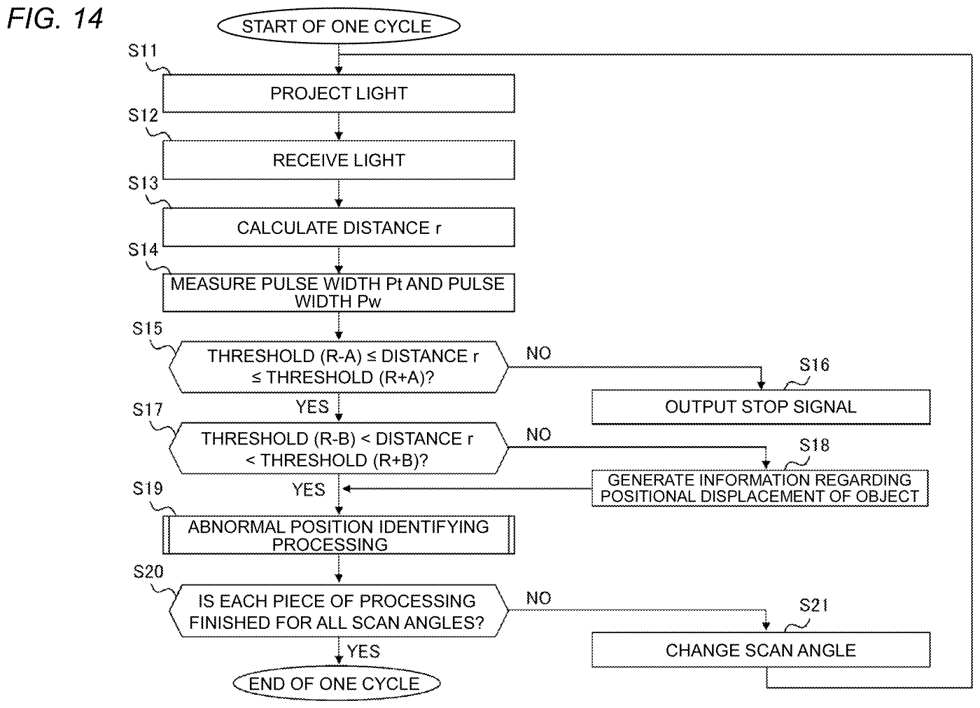

FIG. 14 is a flowchart illustrating an example of reference point monitoring processing. One cycle is started, a predetermined scan angle is set in S11, and the light emitting unit 22 emits (projects) light. In S12, the light receiving unit 23 receives light reflected by a measurement target object. In S13, the signal processor 21 calculates a distance to the measurement target object (hereinafter referred to as distance r). In S14, the acquisition unit 32 acquires, from the sensor 10, a rectangular wave signal (the first rectangular wave signal) obtained by photoelectrical conversion of light reflected by the measurement target object and a rectangular wave signal (the second rectangular wave signal) obtained by photoelectrical conversion of light reflected by the window 101. In S14, the measurement unit 33 measures a width (hereinafter referred to as pulse width pt) of the first rectangular wave signal and a width (hereinafter referred to as pulse width pw) of the second rectangular wave signal.

In S15, the determination unit 34 determines whether or not the distance r is equal to or more than the threshold (R−A) and equal to or less than the threshold (R+A). In a case where the distance r is smaller than the threshold (R−A) or in a case where the distance r is larger than the threshold (R+A) (S15; NO), the processing proceeds to S16. The determination unit 34 may also perform at least one of determination as to whether or not the distance r is smaller than the threshold (R−A) and determination as to whether or not the distance r is larger than the threshold (R+A).

In S16, the generation unit 35 generates and outputs a stop signal for stopping an external device. The stop signal is sent to the external device, and the external device receives the stop signal, so that the external device stops. The generation unit 35 may send a stop signal to an external device via an output signal switching device (OSSD) wired and connected to the sensor unit 1. The OSSD is a device for outputting a safety control signal indicating one of an on state and an off state. The generation unit 35 may transmit a stop signal to an external device by wired communication (for example, EtherNet (registered trademark) communication) or wireless communication.

On the other hand, in a case where the distance r is equal to or more than the threshold (R−A) and the distance r is equal to or less than the threshold (R+A) (S15; YES), the processing proceeds to S17. In S17, the determination unit 34 determines whether or not the distance r is larger than the threshold (R−B) and the distance r is smaller than the threshold (R+B). In a case where the distance r is equal to or less than the threshold (R−B), or in a case where the distance r is equal to or more than the threshold (R+B) (S17; NO), the processing proceeds to S18. The determination unit 34 may also perform at least one of determination as to whether or not the distance r is larger than the threshold (R−B) and determination as to whether or not the distance r is smaller than the threshold (R+B). In a case where the distance r is equal to or more than the threshold (R−A) and the distance r is equal to or less than the threshold (R−B), the determination unit 34 determines that the distance r is included in the first distance range. Further, in a case where the distance r is equal to or more than the threshold (R+B) and the distance r is equal to or less than the threshold (R+A), the determination unit 34 determines that the distance r is included in the second distance range.

In S18, the generation unit 35 generates information regarding positional displacement of a measurement target object. The display device 13 displays information regarding positional displacement of a measurement target object. The information regarding positional displacement of a measurement target object may include at least one of a letter, a number, a symbol, a character string, a number string, a pictogram, a graph, and an image. For example, in a case where a number, a symbol, or the like is displayed on the display device 13 as the information regarding positional displacement of a measurement target object, the user can grasp that the position of the measurement target object is displaced by checking using a manual or the like. Further, the display device 13 may display the information regarding positional displacement of a measurement target object by a glimmering pattern or a blinking pattern. After the processing of S18 is executed, the processing proceeds to S19.

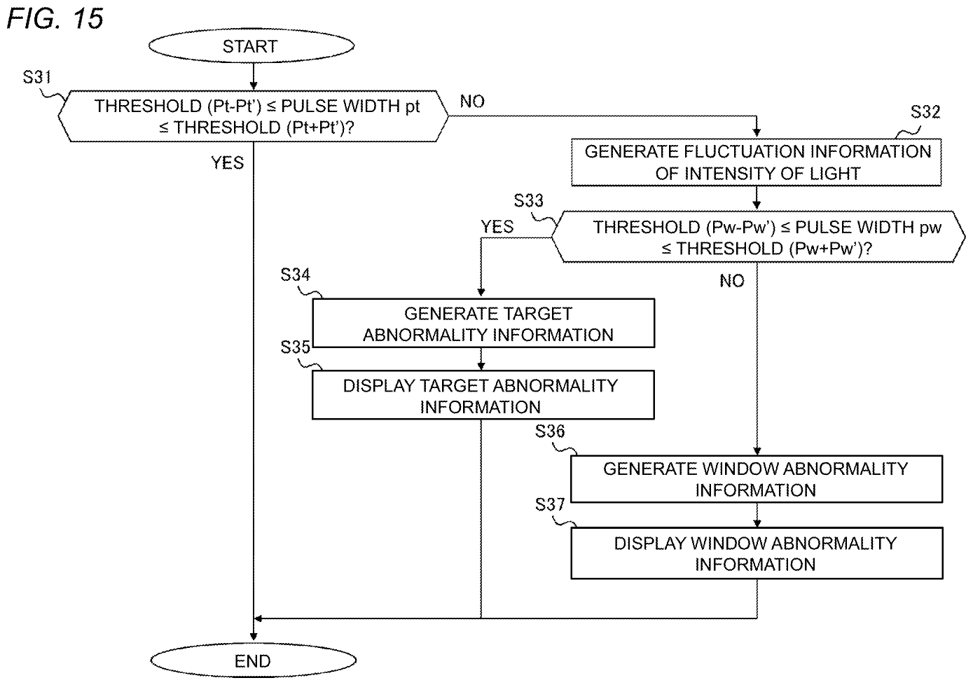

On the other hand, in a case where the distance r is larger than the threshold (R−B) and the distance r is smaller than the threshold (R+B) (S17; YES), the processing proceeds to S19. In a case where the distance r is larger than the threshold (R−B) and the distance r is smaller than the threshold (R+B), the determination unit 34 determines that the distance r is included in the third distance range, and the generation unit 35 does not generate the information regarding positional displacement of an object. In S19, abnormal position identifying processing is executed. FIG. 15 is a flowchart illustrating an example of the abnormal position identifying processing. In S31, the determination unit 34 determines whether or not the pulse width pt is equal to or more than the threshold (Pt−Pt′) and whether or not the pulse width pt is equal to or less than the threshold (Pt+Pt′).

In a case where the pulse width pt is equal to or more than the threshold (Pt−Pt′) and the pulse width pt is equal to or less than the threshold (Pt+Pt′) (S31; YES), the determination unit 34 determines that no abnormality occurs on either the object side or the window 101 side. In this case, the abnormal position identifying processing ends, and the processing proceeds to S20.

On the other hand, in a case where the pulse width pt is smaller than the threshold (Pt−Pt′) or in a case where the pulse width pt is larger than the threshold (Pt+Pt′) (S31; NO), the processing proceeds to S32. In S32, the generation unit 35 generates the fluctuation information of light intensity. In S33, the determination unit 34 determines whether or not the pulse width pw is equal to or more than the threshold (Pw−Pw′) and whether or not the pulse width pw is equal to or less than the threshold (Pw+Pw′).

In a case where the pulse width pw is equal to or more than the threshold (Pw−Pw′) and the pulse width pw is equal to or less than the threshold (Pw+Pw′) (S33; YES), the determination unit 34 determines that abnormality occurs on the measurement target object side, and the processing proceeds to S34. As described above, in a case where negative determination is made in the processing of S31 and positive determination is made in the processing of S33, the determination unit 34 determines that a width of the first rectangular wave signal is not equal to or more than the first predetermined width and equal to or less than the second predetermined width and that a width of the second rectangular wave signal is equal to or more than the third predetermined width and equal to or less than the fourth predetermined width. In S34, the generation unit 35 generates the target abnormality information. In S35, the display device 13 displays the target abnormality information. The target abnormality information may include at least one of a letter, a number, a symbol, a character string, a number string, a pictogram, a graph, and an image. Further, the display device 13 may display the target abnormality information by a glimmering pattern or a blinking pattern. After the processing of S35 is executed, the abnormal position identifying processing ends, and the processing proceeds to S20.

On the other hand, in a case where the pulse width pw is smaller than the threshold (Pw−Pw′), or in a case where the pulse width pw is larger than the threshold (Pw+Pw′) (S33; NO), the determination unit 34 determines that abnormality occurs on the window 101 side, and the processing proceeds to S36. As described above, in a case where negative determination is made in the processing of S31 and negative determination is made in the processing of S33, the determination unit 34 determines that a width of the first rectangular wave signal is not equal to or more than the first predetermined width and equal to or less than the second predetermined width and that a width of the second rectangular wave signal is not equal to or more than the third predetermined width and equal to or less than the fourth predetermined width. In S36, the generation unit 35 generates the window abnormality information. In S37, the display device 13 displays the window abnormality information. The window abnormality information may include at least one of a letter, a number, a symbol, a character string, a number string, a pictogram, a graph, and an image. Further, the display device 13 may display the window abnormality information by a glimmering pattern or a blinking pattern. After the processing of S36 is executed, the abnormal position identifying processing ends, and the processing proceeds to S20.

In S20, the determination unit 34 determines whether each piece of the processing of S11 to S15, S17, and S19 is completed for all scan angles. In a case where each piece of the processing is not completed for all scan angles (Step S20; NO), the processing proceeds to S21, and the determination unit 34 changes the scan angle. One cycle ends when each pieces of the processing is completed for all scan angles. A plurality of cycles may be executed at predetermined intervals (regular or irregular intervals).

By execution of each piece of the processing of S11 to S14 for a plurality of scan angles, the sensor 10 performs measurement in a plurality of directions, and the signal processor 21 outputs the first rectangular wave signal in a plurality of directions and the second rectangular wave signal in a plurality of directions. By executing the processing of S15 for a plurality of scan angles, the determination unit 34 performs at least one of the fourth determination and the fifth determination for a plurality of directions. In a case where a distance to a measurement target object in one of a plurality of directions is determined a predetermined number of times to be shorter than the first predetermined distance or in a case where the distance to the measurement target object in one of a plurality of directions is determined a predetermined number of times to be longer than the fourth predetermined distance, the generation unit 35 generates a stop signal for stopping an external device and sends the stop signal to the external device. By the above, in a case where positional displacement of a measurement target object in one of a plurality of directions exceeds an allowable range, an external device can be stopped.

By executing each piece of the processing of S15 and S17 for a plurality of scan angles, the determination unit 34 performs at least one of the first determination and the second determination for a plurality of directions. In a case where the distance r in one of a plurality of directions is determined a predetermined number of times to be included in the first distance range or in a case where the distance r in one of a plurality of directions is determined a predetermined number of times to be included in the second distance range, the generation unit 35 generates information regarding positional displacement of a measurement target object. The user can grasp the positional displacement of the measurement target object in one of a plurality of directions. By executing each piece of the processing of S15 and S17 for a plurality of scan angles, the determination unit 34 performs the third determination for a plurality of directions. In a case where the distance r in a plurality of directions for which the third determination is performed is determined a predetermined number of times to be included in the third distance range, the generation unit 35 does not generate the information regarding positional displacement of an object.

As the processing of S14 is executed for a plurality of scan angles, the acquisition unit 32 acquires the first rectangular wave signal and the second rectangular wave signal in a plurality of directions from the sensor 10, and the measurement unit 33 measures a width of the first rectangular wave signal and a width of the second rectangular wave signal in a plurality of directions. As the processing of S19 (abnormal position identifying processing) is executed for a plurality of scan angles, the determination unit 34 determines whether or not a width of the first rectangular wave signal in a plurality of directions is equal to or more than the first predetermined width and equal to or less than the second predetermined width. Further, as the processing of S19 (abnormal position identifying processing) is executed for a plurality of scan angles, the determination unit 34 determines whether or not a width of the first rectangular wave signal in a plurality of directions is equal to or more than the third predetermined width and equal to or less than the fourth predetermined width. As the processing of S19 is executed for a plurality of scan angles, the determination unit 34 determines whether abnormality occurs on the object side or the window 101 side on the basis of a width of the first rectangular wave signal in a plurality of directions and a width of the second rectangular wave signal in a plurality of directions.

At least one of the determination unit 34 and the generation unit 35 may have a counter function. At least one of the determination unit 34 and the generation unit 35 may count the number of times of negative determination (NO determination) in each piece of the processing of S15, S17, and S33. At least one of the determination unit 34 and the generation unit 35 may count the number of times of positive determination (YES determination) in the processing of S33.

A first processing example using the counting function will be described. At least one of the determination unit 34 and the generation unit 35 counts the number of times of negative determination in one cycle. In the processing of S15, even if negative determination is made, the processing proceeds to S17 without proceeding to S16. In a case where negative determination is made in the processing of S15 for a plurality of consecutive scan angles in one cycle, the generation unit 35 generates and outputs a stop signal. In a case where the distance r in at least two of a plurality of directions is determined a predetermined number of times to be shorter than the first predetermined distance, the generation unit 35 may generate a stop signal and transmit the stop signal to an external device. In a case where the distance r in at least two of a plurality of directions is determined a predetermined number of times to be longer than the fourth predetermined distance, the generation unit 35 may generate a stop signal and transmit the stop signal to an external device. By the above, in a case where positional displacement of a measurement target object in at least two of a plurality of directions exceeds an allowable range, an external device can be stopped.

Further, in the processing of S17, even if negative determination is made, the processing proceeds to S19 without proceeding to S18. In a case where negative determination is made in the processing of S17 for a plurality of consecutive scan angles in one cycle, the processing proceeds to S18, and the generation unit 35 generates information regarding positional displacement of a measurement target object. In a case where the distance r in at least two of a plurality of directions is determined a predetermined number of times to be included in the first distance range or in a case where the distance r in at least two of a plurality of directions is determined a predetermined number of times to be included in the second distance range, the generation unit 35 may generate information regarding positional displacement of a measurement target object. The user can grasp the positional displacement of the measurement target object in at least two of a plurality of directions.

Further, in the processing of S33, even if positive determination is made, the processing proceeds to S20 without proceeding to S34. In a case where positive determination is made in the processing of S33 for a plurality of consecutive scan angles in one cycle, the processing proceeds to S34, and the generation unit 35 generates the target abnormality information. In a case where it is determined a predetermined number of times that a width of the first rectangular wave signal in at least two directions of a plurality of directions is not equal to or more than the first predetermined width and equal to or less than the second predetermined width and a width of the second rectangular wave signal in the at least two directions is equal to or more than the third predetermined width and equal to or less than the fourth predetermined width, the determination unit 34 may determine that abnormality occurs on the measurement target object side. By the above, for example, in a case where a width of the first rectangular wave signal in at least two of a plurality of directions changes but a width of the second rectangular wave signal in the at least two directions does not change, a position of a cause of occurrence of abnormality is identified to be on the measurement target object side.

Further, in the processing of S33, even if negative determination is made, the processing proceeds to S20 without proceeding to S34. In a case where negative determination is made in the processing of S33 for a plurality of consecutive scan angles in one cycle, the processing proceeds to S34, and the generation unit 35 generates the window abnormality information. In a case where it is determined a predetermined number of times that a width of the first rectangular wave signal in at least two directions of a plurality of directions is not equal to or more than the first predetermined width and equal to or less than the second predetermined width and a width of the second rectangular wave signal in the at least two directions is not equal to or more than the third predetermined width and equal to or less than the fourth predetermined width, the determination unit 34 may determine that abnormality occurs on the window 101 side. By the above, for example, in a case where a width of the first rectangular wave signal and a width of the second rectangular wave signal in at least two of a plurality of directions change, a position of a cause of occurrence of abnormality is identified to be on the window 101 side.

A second processing example using the counting function will be described. At least one of the determination unit 34 and the generation unit 35 counts the number of times of negative determination for the same scan angle in a plurality of cycles. In the processing of S15, even if negative determination is made, the processing proceeds to S17 without proceeding to S16. In a case where negative determination is made in the processing of S15 for the same scan angle over two or more cycles, the generation unit 35 generates and outputs a stop signal. In a case where the distance r in one of a plurality of directions is determined two times or more to be shorter than the first predetermined distance, the generation unit 35 may generate a stop signal and transmit the stop signal to an external device. In a case where the distance r in one of a plurality of directions is determined two times or more to be longer than the fourth predetermined distance, the generation unit 35 may generate a stop signal and transmit the stop signal to an external device.

Further, in the processing of S17, even if negative determination is made, the processing proceeds to S19 without proceeding to S18. In a case where negative determination is made in the processing of S17 for the same scan angle over two or more cycles, the processing proceeds to S18, and the generation unit 35 generates information regarding positional displacement of a measurement target object. As described above, in a case where the distance r in one of a plurality of directions is determined two or more times to be included in the first distance range or in a case where the distance r in one of a plurality of directions is determined two or more times to be included in the second distance range, the generation unit 35 may generate information regarding positional displacement of a measurement target object.

Further, in the processing of S33, even if positive determination is made, the processing proceeds to S20 without proceeding to S34. In a case where positive determination is made in the processing of S33 for the same scan angle over two or more cycles, the processing proceeds to S34, and the generation unit 35 generates the target abnormality information. As described above, in a case where it is determined two times or more that a width of the first rectangular wave signal in one direction of a plurality of directions is not equal to or more than the first predetermined width and equal to or less than the second predetermined width and a width of the second rectangular wave signal in the one direction is equal to or more than the third predetermined width and equal to or less than the fourth predetermined width, the determination unit 34 may determine that abnormality occurs on the measurement target object side. By the above, for example, in a case where a width of the first rectangular wave signal in one direction of a plurality of directions changes but a width of the second rectangular wave signal in the one direction does not change, a position of a cause of occurrence of abnormality is identified to be on the measurement target object side.

Further, in the processing of S33, even if negative determination is made, the processing proceeds to S20 without proceeding to S34. In a case where negative determination is made in the processing of S33 for the same scan angle over two or more cycles, the processing proceeds to S34, and the generation unit 35 generates the window abnormality information. As described above, in a case where it is determined two times or more that a width of the first rectangular wave signal in one direction of a plurality of directions is not equal to or more than the first predetermined width and equal to or less than the second predetermined width and a width of the second rectangular wave signal in the one direction is not equal to or more than the third predetermined width and equal to or less than the fourth predetermined width, the determination unit 34 may determine that abnormality occurs on the window 101 side. By the above, for example, in a case where a width of the first rectangular wave signal and a width of the second rectangular wave signal in one of a plurality of directions change, a position of a cause of occurrence of abnormality is identified to be on the window 101 side.

Each piece of the processing illustrated in FIGS. 13 to 15 may be applied to processing of determining whether abnormality occurs on the object side or the window 101 side based on a width of the first rectangular wave signal and the first received light amount. In this case, in S4 and S14, the optical receiver 104 or a control circuit measures a received light amount of light reflected by the window 101, that is, the first received light amount. The acquisition unit 32 acquires measurement data of the first received light amount from the optical receiver 104 or a control circuit. Note that it is not necessary to determine whether abnormality occurs on the object side or the window 101 side for all scan angles. Whether abnormality occurs on the object side or the window 101 side only needs to be determined for a scan angle corresponding to a position where a plurality of the optical receivers 104 are installed.

Each piece of the processing illustrated in FIGS. 13 to 15 may be applied to reference point monitoring using an analog waveform signal. Each piece of the processing illustrated in FIGS. 13 to 15 may be applied to processing of determining whether abnormality occurs on the object side or the window 101 side based on the elapsed time T1 and the first received light amount.

The generation unit 35 may send at least one of the information regarding positional displacement of a measurement target object, the target abnormality information, and the window abnormality information to an external display device by wired communication or wireless communication. The external display device is a display separate from the sensor unit 1. The external display device is, for example, a liquid crystal display, an organic EL display, or the like. The external display device may be provided in an information processor such as a personal computer, a tablet, or a smartphone.

Note that there is a case where an attachable matter adheres to a surface of a measurement target object, and an attachable matter adheres to a surface of the window 101. In such a case, first, the sensor unit 1 may notify the user that abnormality occurs on the window 101 side. After cleaning of the surface of the window 101 is completed, the sensor unit 1 may notify the user that abnormality occurs on the measurement target object side.

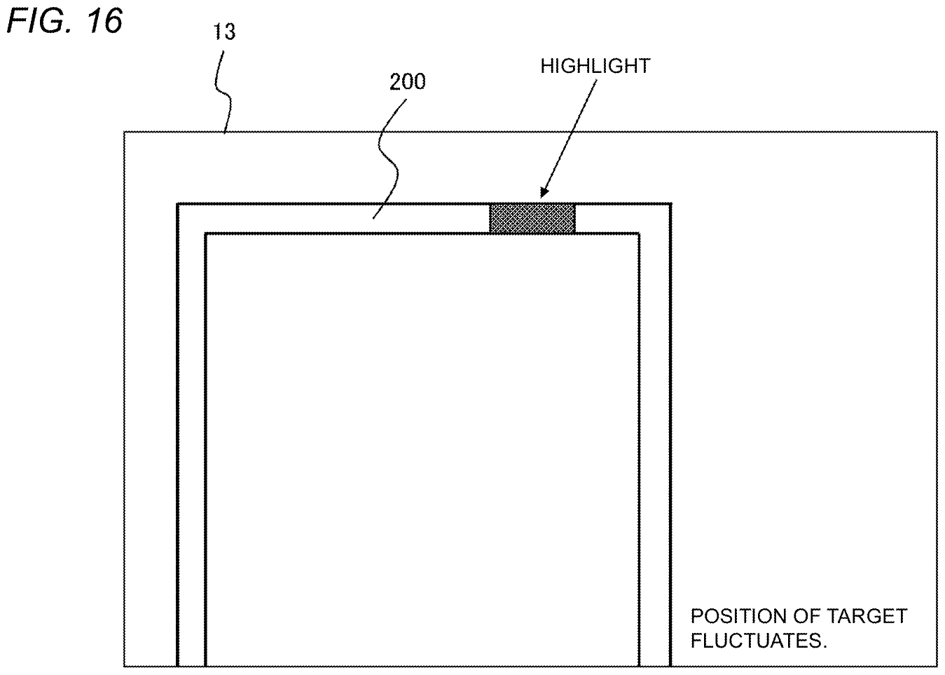

The information regarding positional displacement of a measurement target object may include an outer shape of the measurement target object and a position where the positional displacement of the measurement target object occurs. FIG. 16 is a diagram illustrating an example of a screen of the display device 13. For example, as illustrated in FIG. 16, a position where positional displacement of the frame 200 occurs may be highlighted, and an outer shape of the frame 200 and the position where the positional displacement of the frame 200 occurs may be displayed on a screen of the display device 13. In the example illustrated in FIG. 16, information indicating that a position of a target (the frame 200) is displaced is displayed on the screen of the display device 13.

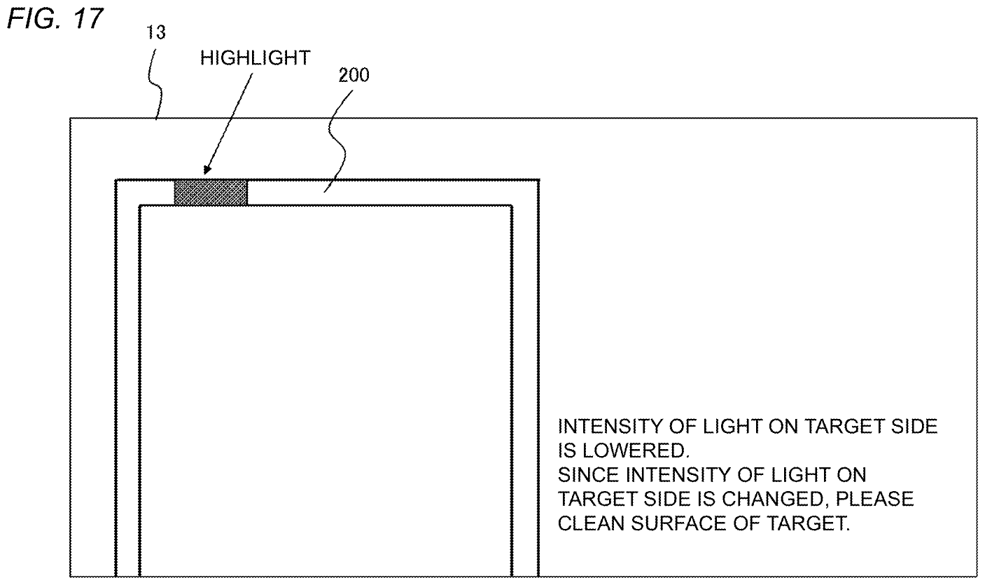

The target abnormality information may include an outer shape of a measurement target object and a position where abnormality occurs on the measurement target object side. FIG. 17 is a diagram illustrating an example of a screen of the display device 13. For example, as illustrated in FIG. 17, a position where abnormality occurs on the frame 200 side may be highlighted, and an outer shape of the frame 200 and the position where the abnormality occurs on the frame 200 side may be displayed on a screen of the display device 13. In the example illustrated in FIG. 17, information indicating that intensity of light on the target (frame 200) side changes and information prompting cleaning of a surface of the target (frame 200) are displayed on a screen of the display device 13.

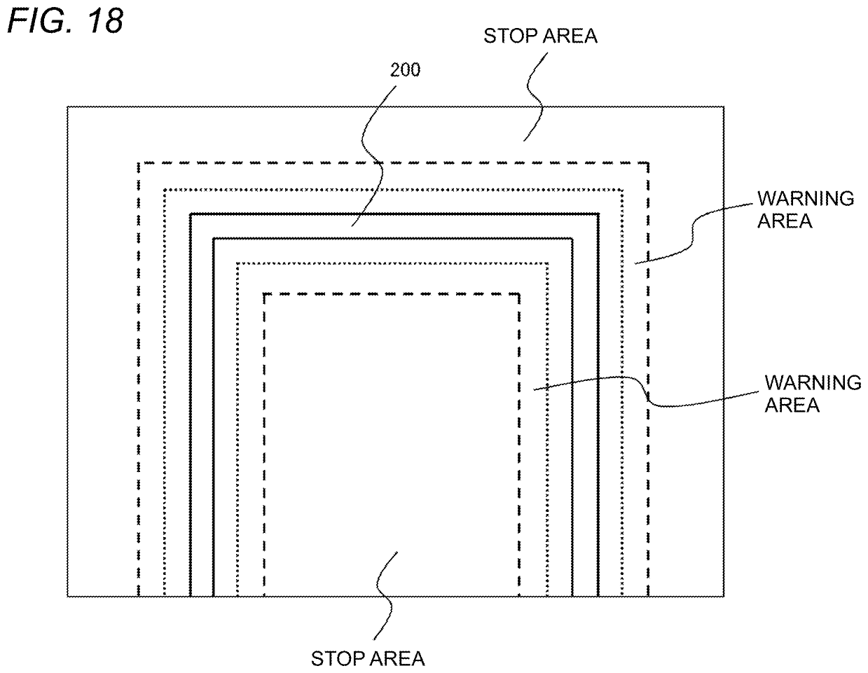

Further, the user may set a stop area and a warning area on a screen of an external display device using a setting tool. FIG. 18 is a diagram illustrating an example of setting of a stop area and a warning area. FIG. 18 illustrates an outer shape of the frame 200, a stop area, and a warning area. The user sets a range of a stop area and a range of a warning area using the setting tool. The range of a warning area may be an allowable range. The user may set the threshold (R−A, R+A) based on a stop area, and may set the threshold (R−B, R+B) based on a warning area.

### Others

The above embodiment merely exemplarily describes the configuration example of the present invention. The present invention is not limited to the specific aspect described above, and various variations can be made within the scope of the technical idea. For example, the sensor unit 1 uses a sensor of a scanner type, but the configuration is not limited to this, and a sensor of a non-scanner type may be used. When a sensor of a non-scanner type is used as the sensor unit 1, a plurality of the sensor units 1 may be provided at an object or in the vicinity of the object.

Each piece of the processing described above may be regarded as a method executed by a computer. Further, a program for causing a computer to execute each piece of the processing described above may be provided to the computer through a network or from a computer-readable recording medium or the like that holds data non-temporarily.

### Supplementary Note 1

A sensor unit (1) including:
a sensor (10) configured to measure a distance to an object by observing light reflected by the object, and photoelectrically converts the light reflected by the object to output a signal;
an acquisition unit (32) configured to acquire the signal;
a determination unit (34) configured to determine whether or not a predetermined condition is satisfied based on rising of the signal and falling of the signal;
a generation unit (35) configured to generate information regarding fluctuation in intensity of the light reflected by the object in a case where the predetermined condition is determined a predetermined number of times not to be satisfied; and
a display (13) configured to display the information regarding fluctuation in intensity of the light reflected by the object.

### Supplementary Note 2

A control method of a sensor unit (1), the control method including:
an acquiring step of acquiring a signal from a sensor (10) configured to measure a distance to an object by observing light reflected by the object and photoelectrically converts the light reflected by the object to output the signal;
a determining step of determining whether or not a predetermined condition is satisfied based on rising of the signal and falling of the signal;
a generating step of generating information regarding fluctuation in intensity of the light reflected by the object in a case where the predetermined condition is determined a predetermined number of times not to be satisfied; and
a displaying step of displaying, on a display (13), the information regarding fluctuation in intensity of the light reflected by the object.

### Supplementary Note 3

A non-transitory computer readable medium storing a program for causing a processor to execute:
an acquiring step of acquiring a signal from a sensor (10) configured to measure a distance to an object by observing light reflected by the object and photoelectrically converts the light reflected by the object to output the signal;
a determining step of determining whether or not a predetermined condition is satisfied based on rising of the signal and falling of the signal;
a generating step of generating information regarding fluctuation in intensity of the light reflected by the object in a case where the predetermined condition is determined a predetermined number of times not to be satisfied; and
a displaying step of displaying, on a display (13), the information regarding fluctuation in intensity of the light reflected by the object.

1. A sensor unit comprising:
a sensor configured to measure a distance to an object by observing light reflected by the object, and photoelectrically converts the light reflected by the object to output a signal;
an acquisition unit configured to acquire the signal;
a determination unit configured to determine whether or not a predetermined condition is satisfied based on rising of the signal and falling of the signal;
a generation unit configured to generate information regarding fluctuation in intensity of the light reflected by the object in a case where the predetermined condition is determined a predetermined number of times not to be satisfied; and
a display configured to display the information regarding fluctuation in intensity of the light reflected by the object.

2. The sensor unit according to claim 1, wherein
the signal is a rectangular wave signal, and
the predetermined condition is a condition that a width of the rectangular wave signal, the width being a width from rising of the rectangular wave signal to falling of the rectangular wave signal, is equal to or more than a first predetermined width and equal to or less than a second predetermined width.

3. The sensor unit according to claim 2, wherein
the sensor includes a light emitting unit, a light receiving unit, a window, and a signal processor,
the signal processor is configured to:
output a first rectangular wave signal by photoelectrically converting light received by the light receiving unit in a case where light that is emitted from the light emitting unit, passes through the window, and is reflected by the object passes through the window and is received by the light receiving unit; and
output a second rectangular wave signal by photoelectrically converting light received by the light receiving unit in a case where light that is emitted from the light emitting unit and reflected by the window is received by the light receiving unit,
the acquisition unit is configured to acquire the first rectangular wave signal and the second rectangular wave signal, and
the determination unit is configured to determine whether abnormality occurs on a side of the object or a side of the window based on a width of the first rectangular wave signal, the width being a width from rising of the first rectangular wave signal to falling of the first rectangular wave signal and a width of the second rectangular wave signal, the width being a width from rising of the second rectangular wave signal to falling of the second rectangular wave signal.

4. The sensor unit according to claim 3, wherein the determination unit is configured to:
determine that abnormality occurs on the side of the object in a case where it is determined a predetermined number of times that a width of the first rectangular wave signal is not equal to or more than the first predetermined width and equal to or less than the second predetermined width and a width of the second rectangular wave signal is equal to or more than a third predetermined width and equal to or less than a fourth predetermined width; and
determine that abnormality occurs on the side of the window in a case where it is determined a predetermined number of times that a width of the first rectangular wave signal is not equal to or more than the first predetermined width and equal to or less than the second predetermined width and a width of the second rectangular wave signal is not equal to or more than the third predetermined width and equal to or less than the fourth predetermined width.

5. The sensor unit according to claim 2, wherein
the sensor includes a light emitting unit, a light receiving unit, a window, a signal processor, an emitter, a reflector, and an optical receiver,
the signal processor is configured to output the rectangular wave signal by photoelectrically converting light received by the light receiving unit in a case where light that is emitted from the light emitting unit, passes through the window, and is reflected by the object passes through the window and is received by the light receiving unit,
the acquisition unit is configured to acquire the rectangular wave signal, and a light amount obtained when light that is emitted from the emitter, passes through the window, and is reflected by the reflector and light that is emitted from the emitter and reflected by the window are received by the optical receiver, and
the determination unit is configured to determine whether abnormality occurs on a side of the object or a side of the window based on a width of the rectangular wave signal, the width being the width from rising of the rectangular wave signal to falling of the rectangular wave signal, and the light amount.

6. The sensor unit according to claim 5, wherein the determination unit is configured to:
determine that abnormality occurs on the side of the object in a case where it is determined a predetermined number of times that a width of the rectangular wave signal is not equal to or more than the first predetermined width and equal to or less than the second predetermined width and the light amount is included in a predetermined range; and
determine that abnormality occurs on the side of the window in a case where it is determined a predetermined number of times that a width of the rectangular wave signal is not equal to or more than the first predetermined width and equal to or less than the second predetermined width and the light amount is not included in the predetermined range.

7. The sensor unit according to claim 1, wherein
the signal is an analog waveform signal, and
the predetermined condition is a condition that elapsed time from a timing at which rising of the analog waveform signal exceeds a first threshold to a timing at which falling of the analog waveform signal falls below a second threshold is equal to or more than first predetermined time and equal to or less than second predetermined time.

8. The sensor unit according to claim 7, wherein
the sensor includes a light emitting unit, a light receiving unit, a window, and a signal processor,
the signal processor is configured to:
output a first analog waveform signal by photoelectrically converting light received by the light receiving unit in a case where light that is emitted from the light emitting unit, passes through the window, and is reflected by the object passes through the window and is received by the light receiving unit; and
output a second analog waveform signal by photoelectrically converting light received by the light receiving unit in a case where light that is emitted from the light emitting unit and reflected by the window is received by the light receiving unit,
the acquisition unit is configured to acquire the first analog waveform signal and the second analog waveform signal, and
the determination unit is configured to determine whether abnormality occurs on a side of the object or a side of the window based on first elapsed time from a timing at which rising of the first analog waveform signal exceeds the first threshold to a timing at which falling of the first analog waveform signal falls below the second threshold, and second elapsed time from a timing at which rising of the second analog waveform signal exceeds a third threshold to a timing at which falling of the second analog waveform signal falls below a fourth threshold.

9. The sensor unit according to claim 8, wherein the determination unit is configured to:
determine that abnormality occurs on the side of the object in a case where it is determined a predetermined number of times that the first elapsed time is not equal to or more than the first predetermined time and equal to or less than the second predetermined time and the second elapsed time is equal to or more than third predetermined time and equal to or less than fourth predetermined time; and
determine that abnormality occurs on a side of the object or a side of the window in a case where it is determined a predetermined number of times that the first elapsed time is not equal to or more than the first predetermined time and equal to or less than the second predetermined time and the second elapsed time is not equal to or more than the third predetermined time and equal to or less than the fourth predetermined time.

10. The sensor unit according to claim 7, wherein
the sensor includes a light emitting unit, a light receiving unit, a window, a signal processor, an emitter, a reflector, and an optical receiver,
the signal processor is configured to output the analog waveform signal by photoelectrically converting light received by the light receiving unit in a case where light that is emitted from the light emitting unit, passes through the window, and is reflected by the object passes through the window and is received by the light receiving unit,
the acquisition unit is configured to acquire the analog waveform signal, and a light amount obtained when light that is emitted from the emitter, passes through the window, and is reflected by the reflector and light that is emitted from the emitter and reflected by the window are received by the optical receiver, and
the determination unit is configured to determine whether abnormality occurs on the object side or the window side based on elapsed time from a timing at which rising of the analog waveform signal exceeds the first threshold to a timing at which falling of the analog waveform signal falls below the second threshold, and the light amount.

11. The sensor unit according to claim 10, wherein the determination unit is configured to:
determine that abnormality occurs on the side of the object in a case where it is determined a predetermined number of times that the elapsed time is not equal to or more than the first predetermined time and equal to or less than the second predetermined time and the light amount is included in a predetermined range; and
determine that abnormality occurs on the side of the window in a case where it is determined a predetermined number of times that the elapsed time is not equal to or more than the first predetermined time and equal to or less than the second predetermined time and the light amount is not included in the predetermined range.

12. The sensor unit according to claim 1, wherein
the sensor is configured to output the signal in a plurality of directions by measuring the plurality of directions,
the acquisition unit is configured to acquire the signal in the plurality of directions,
the determination unit is configured to determine whether or not the predetermined condition is satisfied based on rising of the signal and falling of the signal in at least one direction of the plurality of directions, and
the generation unit is configured to generate information regarding fluctuation in intensity of light reflected by the object in a case where the predetermined condition is determined a predetermined number of times not to be satisfied for at least one direction of the plurality of directions.

13. The sensor unit according to claim 3, wherein
the generation unit is configured to generate information regarding abnormality on the side of the object in a case where the determination unit determines that abnormality occurs on the side of the object, and generate information regarding abnormality on the side of the window in a case where the determination unit determines that abnormality occurs on the side of the window, and
the display is configured to display the information regarding abnormality on the side of the object or the information regarding abnormality on the side of the window.

14. A control method of a sensor unit, the control method comprising:
an acquiring step of acquiring a signal from a sensor configured to measure a distance to an object by observing light reflected by the object and photoelectrically convert the light reflected by the object to output the signal;
a determining step of determining whether or not a predetermined condition is satisfied based on rising of the signal and falling of the signal;
a generating step of generating information regarding fluctuation in intensity of the light reflected by the object in a case where the predetermined condition is determined a predetermined number of times not to be satisfied; and
a displaying step of displaying, on a display, the information regarding fluctuation in intensity of the light reflected by the object.

15. A non-transitory computer readable medium storing a program for causing a processor to execute:
an acquiring step of acquiring a signal from a sensor configured to measure a distance to an object by observing light reflected by the object and photoelectrically convert the light reflected by the object to output the signal;
a determining step of determining whether or not a predetermined condition is satisfied based on rising of the signal and falling of the signal;
a generating step of generating information regarding fluctuation in intensity of the light reflected by the object in a case where the predetermined condition is determined a predetermined number of times not to be satisfied; and
a displaying step of displaying, on a display, the information regarding fluctuation in intensity of the light reflected by the object.
